(19) United States
(12) Patent Application Publication
(10) Pub. No.: US 2026/0236299 A1
(43) Pub. Date: Aug. 13, 2026

(54) METHOD AND SYSTEM FOR ADDING TASKS IN MULTI-TASKING MODELS

(71) Applicant: LG MANAGEMENT DEVELOPMENT INSTITUTE CO., LTD., Seoul (KR)

(72) Inventors: Dae Woong JEONG, Seoul (KR); Sung Moon KO, Gimpo-si (KR); Su Min LEE, Seoul (KR); Hyun Seung KIM, Seoul (KR); Soo Rin YIM, Seoul (KR)

(21) Appl. No.: 19/633,790

(22) Filed: Mar. 30, 2026

Related U.S. Application Data
(63) Continuation of application No. PCT/KR2025/007177, filed on May 27, 2025.

(30) Foreign Application Priority Data
Jul. 25, 2024 (KR) 10-2024-0098939

(51) Int. Cl. G06F 9/48; G06N 20/00

(52) U.S. Cl. CPC G06F 9/4881; G06N 20/00

(57) ABSTRACT

A method for adding tasks to a multi-tasking model, which corresponds to a method for expanding tasks of a multi-tasking model by a computing system including a memory and a processor, including: performing primary training of the multi-tasking model based on first experimental data so as to learn first multi-tasks; obtaining second experimental data for training the multi-tasking model on new tasks other than the first multi-tasks; performing secondary training of the primarily-trained multi-tasking model based on the obtained second experimental data; and providing the secondarily-trained multi-tasking model. The performing of the secondary training of the multi-tasking model includes freezing at least some parameters of the primarily-trained multi-tasking model and performing additional training of the multi-tasking model on the new tasks.

### CROSS REFERENCE TO RELATED APPLICATIONS

This application is a Bypass Continuation of International Patent Application No. PCT/KR2025/007177, filed on May 27, 2025, which claims priority from and the benefit of Korean Patent Application No. 10-2024-0098939, filed on Jul. 27, 2024, which are hereby incorporated by reference for all purposes as if fully set forth herein.

### BACKGROUND

### Field

Embodiments of the invention relate generally to a method and a system for expanding tasks of a multi-tasking model and, more particularly, to a method and a system for expanding tasks of a multi-tasking model through geometric alignment in an integrated latent space.

### Discussion of the Background

Machine learning and artificial intelligence models require large-scale data. However, in practice, there are inherent limitations in always securing sufficient data. This challenge becomes even more pronounced when attempting to apply models to new domains or tasks. Molecular structure data sets are a great example of this situation. In the fields of chemistry and pharmacology, data are required to predict the properties of new molecules, but obtaining experimental data for each molecule is difficult and incurs significant cost. Accordingly, the need for transfer learning techniques that apply knowledge from pre-trained models to new tasks has increased.

However, existing transfer learning techniques have been developed mainly focusing on classification problems involving large-scale data sets, such as image or text data. As a result, existing transfer learning techniques exhibit limitations when applied to regression problems or small-scale, complex data sets such as molecular data sets. In particular, molecular structure data are high-dimensional, and the relationships between individual components and bonds have a significant impact on physical properties. Consequently, when applying transfer learning techniques in which a model learns the relationship between one physical property and molecular structure data and then attempts to transfer this knowledge to the relationship between another physical property and molecular structure data, existing Euclidean space-based transfer learning techniques fail to effectively handle the complex structures in such non-Euclidean spaces.

In this regard, Riemannian geometry enables calculus on curved spaces, allowing for more expressive representation and analysis of complex data structures. Such Riemannian geometric approaches assume that latent vectors exist on curved manifolds, which is advantageous in geometric alignment between complex source and target tasks.

However, existing Riemannian geometric approaches, while capable of supporting high-performance knowledge transfer across diverse tasks, suffer from significantly increased calculation complexity in situations of dealing with large-scale data sets or a large number of tasks.

Therefore, based on the above background, there is a need for a new technology that may efficiently learn various tasks while reducing calculation cost, achieve high prediction performance and stability even with small-scale data sets, implement more effective transfer learning, and simultaneously enhance model normalization performance to improve model generalization performance.

The above information disclosed in this Background section is only for understanding of the background of the inventive concepts, and, therefore, it may contain information that does not constitute prior art.

### SUMMARY

An embodiment of the invention is intended to provide a method and a system for expanding tasks of a multi-tasking model through geometric alignment in an integrated latent space.

In this regard, an embodiment of the invention provides a method and a system for expanding tasks of a multi-tasking model by primarily performing pre-training of the multi-tasking model and secondarily performing additional training based on a parameter freezing technique on the pre-trained multi-tasking model.

In addition, an embodiment of the invention provides a method and a system for adding tasks to a multi-tasking model, which perform transfer learning through geometric alignment in an integrated latent space for multi-tasks corresponding to a plurality of domains during the pre-training.

In addition, an embodiment of the invention provides a method and a system for adding tasks to a multi-tasking model, which simultaneously train various prediction tasks corresponding to a plurality of domains in the transfer learning process to achieve collective learning of not only individual principles of the respective domains but also correlations between the domains and a common principle for the entire domains.

In addition, an embodiment of the invention provides a method and a system for adding tasks to a multi-tasking model, which implement mutual exchange of information by aligning geometric characteristics of the various prediction tasks.

In addition, an embodiment of the invention provides a method and a system for adding tasks to a multi-tasking model, which secure data sets for training by utilizing source data from various sources.

In addition, an embodiment of the invention provides a multi-tasking model which applies the multi-tasking learning model trained as described above to the prediction of relationships between a plurality of physical properties and materials, thereby enabling prediction of a plurality of physical properties for a specific material and prediction of a specific material that satisfies a plurality of physical properties.

Additional features of the inventive concepts will be set forth in the description which follows, and in part will be apparent from the description, or may be learned by practice of the inventive concepts.

According to one or more embodiments of the invention, a method for adding tasks to a multi-tasking model, which corresponds to a method for expanding tasks of a multi-tasking model by a computing system including a memory and a processor, includes: performing primary training of the multi-tasking model based on first experimental data so as to learn first multi-tasks; obtaining second experimental data for training the multi-tasking model on new tasks other than the first multi-tasks; performing secondary training of the primarily-trained multi-tasking model based on the obtained second experimental data; and providing the secondarily-trained multi-tasking model. The performing of the secondary-training of the multi-tasking model includes freezing at least some parameters of the primarily-trained multi-tasking model and performing additional training of the multi-tasking model on the new tasks.

The performing of the primary training of the multi-tasking model may include: obtaining geometric alignment vectors supporting geometric alignment among data corresponding to the first multi-tasks in a single integrated latent space (manifold) based on the first experimental data; calculating geometric alignment losses based on the obtained geometric alignment vectors; and updating parameters of the multi-tasking model based on the calculated geometric alignment losses.

The updating of the parameters of the multi-tasking model may include updating parameters of N (N≥2) task processing units respectively corresponding to N (N≥2) domains of the first multi-tasks.

The updating of the parameters of the multi-tasking model may further include updating parameters of an embedding module configured to project the first experimental data into a predetermined embedding space and convert the projected data into vector form.

The new tasks may include tasks having domains different from domains of the first multi-tasks, or tasks having the same domains as the first multi-tasks but having different experimental data corresponding to the same domains.

The performing of the secondary training of the multi-tasking model may further include performing additional training of M (M≥1) task processing units configured to process the new tasks in the primarily-trained multi-tasking model.

The performing of the additional training of the task processing units may include freezing the parameters of the N (N≥2) primarily-trained task processing units and the parameters of the primarily-trained embedding module, and performing additional training of the M (M≥1) task processing units.

The performing of the additional training of the task processing units may include: obtaining geometric alignment vectors based on the second experimental data; calculating geometric alignment losses based on the obtained geometric alignment vectors; and updating parameters of the M (M≥1) task processing units based on the calculated geometric alignment losses.

The experimental data may include intrinsic material characteristic information specifying intrinsic characteristics of a predetermined material, and material physical property-specific information specifying characteristic values of the material with respect to a plurality of physical properties.

The providing of the secondarily-trained multi-tasking model may include: inputting the intrinsic material characteristic information to the secondarily-trained multi-tasking model; and outputting the material physical property-specific information corresponding to the input intrinsic material characteristic information.

According to yet another embodiment of the invention, a system for adding tasks to a multi-tasking model includes: at least one memory; and at least one processor configured to read at least one application stored in the memory to expand tasks to the multi-tasking model. Instructions of the processor include instructions for executing: performing primary training of the multi-tasking model based on first experimental data so as to learn first multi-tasks; obtaining second experimental data for training the multi-tasking model on new tasks other than the first multi-tasks; performing secondary training of the primarily-trained multi-tasking model based on the obtained second experimental data; and providing the secondarily-trained multi-tasking model. The instructions of the processor include an instruction for executing freezing at least some parameters of the primarily-trained multi-tasking model and performing additional training of the multi-tasking model on the new tasks.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 illustrates an example of a block diagram of a computing system implementing a multi-tasking model task addition service according to an embodiment of the invention.

FIG. 2 illustrates an example of a block diagram of a computing device implementing a multi-tasking model task addition service according to an embodiment of the invention.

FIG. 3 illustrates an example of a block diagram from another perspective of a computing device implementing a multi-tasking model task addition service according to an embodiment of the invention.

FIG. 4 and FIG. 5 illustrate examples of conceptual diagrams for describing a multi-tasking learning model according to an embodiment of the invention.

FIG. 6 illustrates an example of a conceptual diagram of a multi-tasking learning model for predicting a plurality of physical property values for a specific material according to an embodiment of the invention.

FIG. 7 illustrates an internal block diagram of a multi-tasking learning model according to an embodiment of the invention.

FIG. 8 illustrates an example of a conceptual diagram for describing a multi-tasking learning model including a plurality of task processing units according to an embodiment of the invention.

FIG. 9 illustrates an example of a conceptual diagram for describing a multi-tasking model pre-training method according to an embodiment of the invention.

FIG. 10 is a flowchart for illustrating a multi-tasking model pre-training method according to an embodiment of the invention.

FIG. 11 illustrates an example of a knowledge graph showing relationships among physical properties according to an embodiment of the invention.

FIG. 12 is a flowchart for describing a multi-tasking learning model training method according to an embodiment of the invention.

FIG. 13 illustrates an example of a first conceptual diagram for describing a multi-tasking learning model training method according to an embodiment of the invention.

FIG. 14 illustrates an example of a second conceptual diagram for describing a multi-tasking learning model training method according to an embodiment of the invention.

FIG. 15 and FIG. 16 illustrate examples of diagrams for describing a regression loss calculation method according to an embodiment of the invention.

FIG. 17 illustrates an example of a diagram for describing an integrated latent space mapping method according to an embodiment of the invention.

FIG. 18 and FIG. 19 illustrate examples of diagrams for describing a consistency loss calculation method according to an embodiment of the invention.

FIG. 20 and FIG. 21 illustrate examples of diagrams for describing a mapping loss calculation method according to an embodiment of the invention.

FIG. 22 illustrates an example of a diagram for describing an integrated loss calculation method according to an embodiment of the invention.

FIG. 23 is a flowchart for describing a method for adding tasks to a multi-tasking model according to an embodiment of the invention.

FIG. 24 illustrates an example of a conceptual diagram for describing a method for adding tasks to a multi-tasking model according to an embodiment of the invention.

FIG. 25 illustrates an example of a conceptual diagram for describing an expansion-training method according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

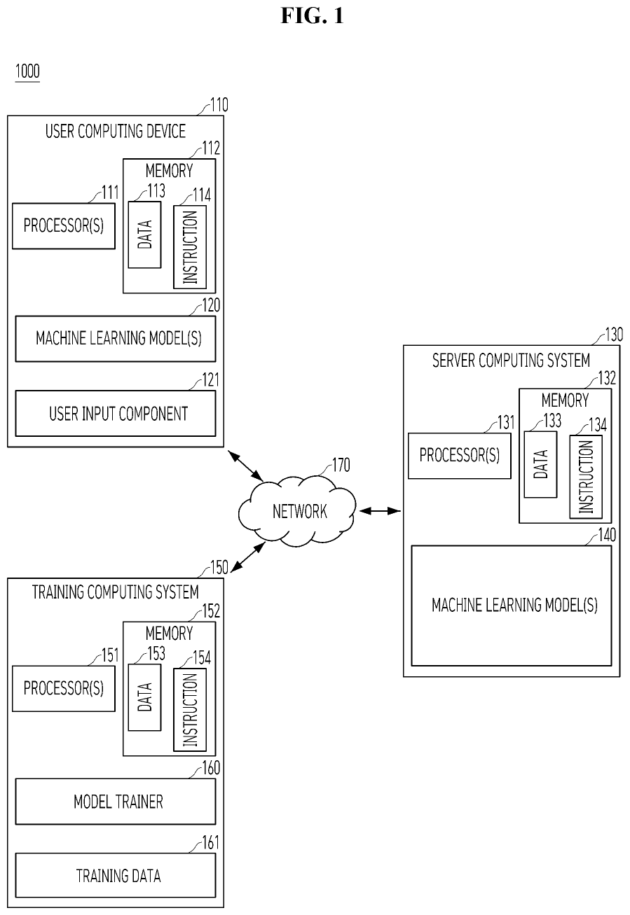

FIG. 1 illustrates an example of a block diagram of a computing system implementing a multi-tasking model task addition service according to an embodiment of the invention.

Referring to FIG. 1, a computing system 1000 implementing a multi-tasking model task addition service according to the invention includes a user computing device 110, a server computing system 130, and a training computing system 150, and the devices are communicable through a network 170.

A method and a system for adding tasks to a multi-tasking model, according to an embodiment of the invention, may be: 1) implemented and provided locally by the user computing device 110; 2) implemented and provided in the form of a web service by the server computing system 130 in communication with the user computing device 110; and 3) implemented and provided by the user computing device 110 and the server computing system 130 in association with each other.

In this regard, in an embodiment, the user computing device 110 and/or the server computing system 130 may train machine learning models 120 and/or 140 through interaction with the training computing system 150 communicatively connected thereto via the network 170. The training computing system 150 may be separate from the server computing system 130 or may be part of the server computing system 130.

In this regard, an artificial intelligence model may be: 1) directly trained by the user computing device 110 locally; 2) trained by the server computing system 130 and the user computing device 110 interacting with each other through the network 170; and 3) trained by the separate training computing system 150 using various training techniques and learning techniques. Further, the artificial intelligence model trained by the training computing system 150 may be transmitted to the user computing device 110 and/or the server computing system 130 through the network 170 for provision/update.

In some embodiments, the training computing system 150 may be part of the server computing system 130, or may be part of the user computing device 110.

The user computing device 110 may include all other types of computing devices such as smart phones, mobile phones, digital broadcasting devices, personal digital assistants (PDA), portable multimedia players (PMP), desktops, wearable devices, embedded computing devices, and/or tablet PCs.

Such a user computing device 110 includes at least one processor 111 and a memory 112. In this regard, the processor 111 may include at least one of a central processing unit (CPU), a graphics processing unit (GPU), an application specific integrated circuit (ASIC), a digital signal processor (DSP), a digital signal processing device (DSPD), a programmable logic device (PLD), a field programmable gate array (FPGA), a controller, a micro-controller, a microprocessor, and/or electrical units for performing other functions, or a plurality of electrically connected processors.

The memory 112 may include one or more non-transitory/transitory computer-readable storage media such as RAM, ROM, EEPROM, EPROM, flash memory devices, magnetic disks, and the like, and combinations thereof, and may include web storage of a server that performs a storage function of the memory on the Internet. Such a memory 112 may store data 113 and instructions 114 necessary for the at least one processor 111 to perform functional operations such as training an artificial intelligence model or executing multi-tasking learning through the artificial intelligence model.

In an embodiment, the user computing device 110 may store one or more machine learning models 120.

In detail, the machine learning models 120 may be various machine learning models, such as a plurality of neural networks (e.g., a deep neural network), or other types of machine learning models, including non-linear models and/or linear models, or may be composed of combinations thereof.

In this regard, the neural networks may include at least one of a feed-forward neural network, a recurrent neural network (e.g., long and short-term memory recurrent neural networks), a convolutional neural network, and/or other types of neural networks.

In an embodiment, the user computing device 110 may receive one or more machine learning models 120 from the server computing system 130 through the network 170, store the machine learning models 120 in the memory 112, and then execute the stored machine learning models 120 by the processor 111 to perform multi-tasking learning and the like. In another embodiment, the server computing system 130 may include one or more machine learning models 140 to perform an operation using the machine learning models 140, and may provide a multi-tasking model task addition service to a user by interoperating with the user computing device 110 in a manner of exchanging data related thereto with the user computing device 110.

For example, the user computing device 110 may perform the multi-tasking model task addition service in a manner in which the server computing system 130 provides output for user's input using the machine learning models 140 through the web.

In addition, the artificial intelligence models may be implemented in a manner in which at least some of the machine learning models 120 and/or 140 are executed in the user computing device 110, and the rest are executed in the server computing system 130.

In addition, the user computing device 110 may include at least one input component 121 that senses a user's input. For example, the user input component 121 may include a touch sensor (e.g., a touch screen and/or a touch pad) that senses a touch of a user's input medium (e.g., a finger or a stylus), an image sensor that senses a user's motion input, a microphone that senses a user's voice input, a button, a mouse, and/or a keyboard. In addition, when receiving input to an external controller (e.g., a mouse and/or a keyboard) through an interface, the user input component 121 may include the interface and the external controller.

The server computing system 130 includes at least one processor 131 and a memory 132. In this regard, the processor 131 may include at least one of a central processing unit (CPU), a graphics processing unit (GPU), an application specific integrated circuit (ASIC), a digital signal processor (DSP), a digital signal processing device (DSPD), a programmable logic device (PLD), a field programmable gate array (FPGA), a controller, a micro-controller, a microprocessor, and/or electrical units for performing other functions, or a plurality of electrically connected processors.

In addition, the memory 132 may include one or more non-transitory/transitory computer-readable storage media such as RAM, ROM, EEPROM, EPROM, flash memory devices, magnetic disks, and the like, and combinations thereof. Such a memory 132 may store data 133 and instructions 134 necessary for the processor 131 to perform functional operations such as training an artificial intelligence model or executing multi-tasking learning through the artificial intelligence model.

In an embodiment, the server computing system 130 may be implemented including at least one computing device. For example, the server computing system 130 may be implemented to operate a plurality of computing devices according to a sequential computing architecture, a parallel computing architecture, or a combination thereof. In addition, the server computing system 130 may include a plurality of computing devices connected to each other via the network 170.

In addition, the server computing system 130 may store the one or more machine learning models 140. For example, the server computing system 130 may include neural networks and/or other multi-layer non-linear models as the machine learning models 140. Exemplary neural networks may include feed forward neural networks, deep neural networks, recurrent neural networks, and convolutional neural networks.

The training computing system 150 includes at least one processor 151 and a memory 152. In this regard, the processor 151 may include at least one of a central processing unit (CPU), a graphics processing unit (GPU), an application specific integrated circuit (ASIC), a digital signal processor (DSP), a digital signal processing device (DSPD), a programmable logic device (PLD), a field programmable gate array (FPGA), a controller, a micro-controller, a microprocessor, and/or electrical units for performing other functions, or a plurality of electrically connected processors.

In addition, the memory 152 may include one or more non-transitory/transitory computer-readable storage media such as RAM, ROM, EEPROM, EPROM, flash memory devices, magnetic disks, and the like, and combinations thereof. Such a memory 152 may store data 153 and instructions 154 necessary for the processor 151 to perform training of an artificial intelligence model or the like.

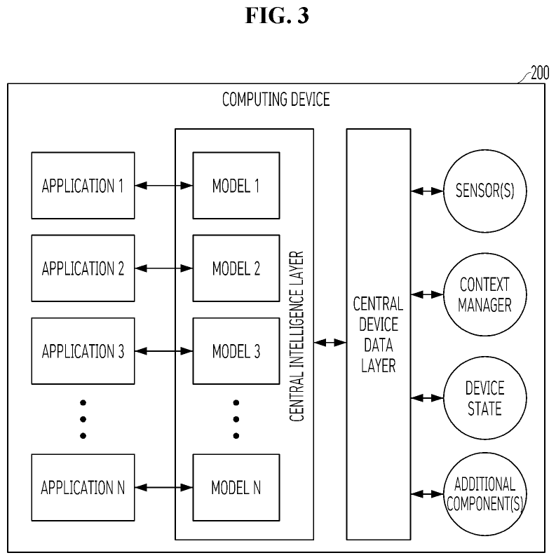

For example, the training computing system 150 may include a model trainer 160 that trains the machine learning models 120 and/or 140 stored in the user computing device 110 and/or the server computing system 130 using various training or learning techniques such as backpropagation of errors (according to the framework shown in FIG. 3).

As an example, such a model trainer 160 may perform updates of one or more parameters of the machine learning models 120 and/or 140 in a backpropagation manner based on a defined loss function.

In some implementations, performing the backpropagation of errors may include performing truncated backpropagation through time. The model trainer 160 may perform a number of generalization techniques (e.g., weight reduction, drop-out, knowledge distillation, etc.) to improve the generalization ability of the trained machine learning models 120 and/or 140.

In particular, the model trainer 160 may train the machine learning models 120 and/or 140 based on a series of training data 161. In this regard, the training data 161 may include different modalities of data, such as, for example, images, audio samples, and/or text. Examples of image types that may be used may include video frames, LiDAR point clouds, X-ray images, computed tomography scans, hyperspectral images, and/or various other forms of images.

Such training data 161 may be provided by the user computing device 110 and/or the server computing system 130. When the training computing device trains the machine learning models 120 and/or 140 on specific data of the user computing device 110, the machine learning models 120 and/or 140 may be characterized as “personalized models”.

In addition, the model trainer 160 includes computer logic utilized to provide desired functionality.

In addition, the model trainer 160 may be implemented as hardware, firmware, and/or software that controls a general-purpose processor. In one implementation, the model trainer 160 may include a program file stored in a storage device, may be loaded into the memory 152, and may be executed by the one or more processors 151. In another implementation, the model trainer 160 includes one or more sets of computer-executable data 153 and instructions 154 stored in tangible computer-readable storage media, such as RAM hard disks or optical or magnetic media.

The network 170 includes, but is not limited to, a 3rd generation partnership project (3GPP) network, a long term evolution (LTE) network, a world interoperability for microwave access (WIMAX) network, the Internet, a local area network (LAN), a wireless local area network (wireless LAN), a wide area network (WAN), a personal area network (PAN), a Bluetooth network, a satellite broadcasting network, an analog broadcasting network, and/or a digital multimedia broadcasting (DMB) network.

In general, communication over the network 170 may be performed using any type of wired and/or wireless connection, via various communication protocols (e.g., TCP/IP, HTTP, SMTP, and/or FTP), encoding or formats (e.g., HTML and/or XML), and/or protection schemas (e.g., VPN, secure HTTP, and/or SSL).

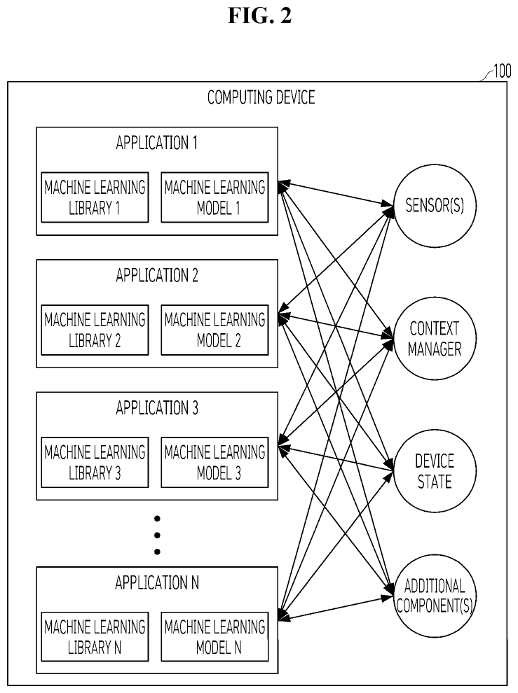

FIG. 2 illustrates an example of a block diagram of a computing device implementing a multi-tasking model task addition service according to an embodiment of the invention.

Referring to FIG. 2, a computing device 100 is included in each of the user computing device 110, the server computing system 130, and the training computing system 150 and includes multiple applications (e.g., applications 1 to N). Each application may include a machine learning library and one or more machine learning models. For example, the applications may include an image processing (e.g., detection, classification, and/or segmentation) application, a text messaging application, an email application, a dictation application, a virtual keyboard application, a browser application, and/or a chat-bot application.

In an embodiment, the computing device 100 may include the model trainer 160 for training artificial intelligence models, and may store and operate the trained artificial intelligence models, thereby providing output data according to predetermined input data (e.g., intrinsic material characteristic information and/or material physical property-specific information).

Each application of the computing device 100 may be in communication with a number of other components of the computing device 100, such as, for example, at least one sensor, a context manager, a device status component, and/or additional components. In an embodiment, each application may be in communication with each device component using an API (e.g., a public API). In an embodiment, an API used by each application may be specific to that application.

FIG. 3 illustrates an example of a block diagram from another perspective of a computing device implementing a multi-tasking model task addition service according to an embodiment of the invention.

Referring to FIG. 3, a computing device 200 includes multiple applications (e.g., applications 1 to N). Each application may be in communication with a central intelligence layer. For example, the applications may include an image processing application, a text message application, an email application, a dictation application, a virtual keyboard application, and/or a browser application. In an embodiment, each application may be in communication with the central intelligence layer (and models stored therein) using an API (e.g., a common API across all applications).

The central intelligence layer may include multiple machine learning models. For example, as shown in FIG. 3, at least some of the machine learning models may be provided for the respective applications and managed by the central intelligence layer. In another implementation, two or more applications may share a single machine learning model. For example, in some implementations, the central intelligence layer may provide a single model for all applications. In some implementations, the central intelligence layer may be included within the operating system of the computing device 200 or implemented otherwise.

The central intelligence layer may be in communication with a central device data layer. The central device data layer may be centralized data storage for the computing device 200. As shown in FIG. 3, the central device data layer may be in communication with multiple other components of the computing device 200, such as, for example, one or more sensors, a context manager, a device status component, and/or additional components. In some implementations, the central device data layer may be in communication with each device component using an API (e.g., a private API).

The technology described herein may refer to servers, databases, software applications, and other computer-based systems, as well as actions taken and information transmitted to or from such systems. It will be appreciated that the inherent flexibility of computer-based systems allows for a wide range of possible configurations, combinations, divisions of tasks, and functionality among components and from such components. For example, the processes described herein may be implemented using a single device or component, or multiple devices or components operating in combination. Databases and applications may be implemented in a single system or in distributed systems across multiple systems. Distributed components may operate sequentially or in parallel.

### [Multi-Tasking Learning Model MtLM]

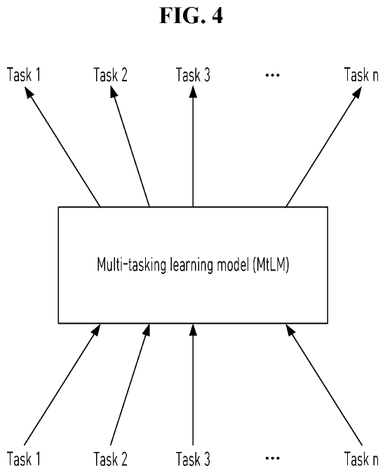

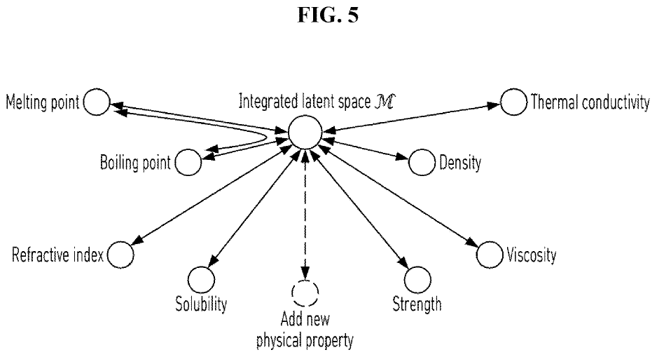

FIGS. 4 and 5 illustrate examples of conceptual diagrams for describing a multi-tasking learning model MtLM according to an embodiment of the invention.

Referring to FIGS. 4 and 5, a multi-tasking learning model MtLM (geometrically aligned transfer encoder model) according to an embodiment of the invention may be a machine learning model in which knowledge data (e.g., latent vectors, etc.) fragmented in latent spaces for respective tasks are mutually aligned in a single integrated latent space M (manifold) through a geometric transfer in order to process multi-tasks for an integrated output satisfying a plurality of domains.

In this regard, for reference, a latent space according to an embodiment may refer to a high-dimensional space in which predetermined data is located after being converted through an encoding process. In this space, important characteristics of the data may be represented in a compressed form.

The integrated latent space M according to an embodiment may refer to a virtual local flat (LF) space in which predetermined data are geometrically represented, and a transformation between one latent space and the integrated latent space M may serve to align geometric characteristics of the data.

In other words, the multi-tasking learning model MtLM according to an embodiment may not only learn knowledge data corresponding to various domains at the same time, but also efficiently learn relationships among various domains, thereby performing effective multi-tasking learning that expands a learning area and simultaneously implements collective learning of a local pattern corresponding to each domain and a common principle shared across the plurality of domains.

Accordingly, the multi-tasking learning model MtLM may directly improve the processing performance and accuracy of various multi-tasking tasks based on the model trained as described above.

In the following embodiment, the multi-tasking learning model MtLM will be described using an example of relationships between a predetermined material and a plurality of physical properties, and will be described as a learning model for multi-tasking a plurality of tasks including a first task for predicting characteristics of a first physical property of the material, a second task for predicting characteristics of a second physical property of the material, and the like. However, it should be understood that the inventive concepts are not limited to a learning method and a prediction method for multi-tasking relationships between a material and a plurality of physical properties, and may be applied to all various tasks in which a plurality of tasks, such as relationships between a material and a plurality of physical properties, are to be simultaneously performed.

Accordingly, a domain according to the following embodiment may refer to a category (field) for predicting a predetermined physical property (e.g., boiling point, melting point, refractive index, solubility, viscosity, surface tension, density, strength, and/or thermal conductivity).

In an embodiment, such a multi-tasking learning model MtLM may perform pre-learning based on predetermined experimental data.

In this regard, the experimental data according to an embodiment may refer to training data used for training the multi-tasking learning model MtLM, and may include predetermined input data and output data (i.e., label) information corresponding thereto.

In an embodiment, such experimental data may be data including predetermined intrinsic material characteristic information and material physical property-specific information corresponding thereto. That is, in an embodiment, the experimental data may be data in which predetermined intrinsic material characteristic information is used as input data, and material physical property-specific information is included as output data (i.e., label) mapped to the input intrinsic material characteristic information.

In this regard, the intrinsic material characteristic information according to an embodiment may be information specifying unique characteristics possessed by a predetermined material.

For example, the intrinsic material characteristic information may include at least one of a predetermined material name, a molecular structural formula, and/or chemical formula data. In the following description, the intrinsic material characteristic information is limited to molecular structural formula (e.g., n-dimensional (n≥2) molecular structural formula) data.

In addition, the material physical property-specific information according to an embodiment may be information specifying data values (i.e., characteristic values of physical properties, where the values include ranges) that a predetermined material has with respect to predetermined physical properties.

For example, the material physical property-specific information may include physical property (i.e., domain) values such as boiling point, melting point, refractive index, solubility, viscosity, surface tension, density, strength, and/or thermal conductivity of a predetermined material.

In the following embodiment, molecular structural formula data indicating the intrinsic material characteristic information will be used as input data, and physical property value data for each task will be used as output data.

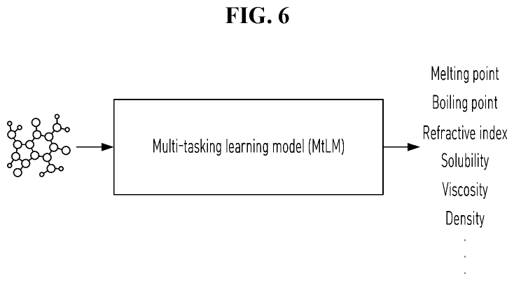

FIG. 6 illustrates an example of a conceptual diagram of a multi-tasking learning model for predicting a plurality of physical property values for a specific material according to an embodiment of the invention.

Therefore, referring to FIG. 6, the multi-tasking learning model MtLM according to an embodiment of the invention may be a multi-tasking model that performs multi-tasks of predicting outputs for the plurality of respective domains (e.g., a plurality of physical properties such as boiling point, melting point, refractive index, solubility, viscosity, surface tension, density, strength, and/or thermal conductivity) based on predetermined input data (e.g., predetermined molecular structural formula data, etc.).

Accordingly, the above-described tasks may be to predict outputs (i.e., the plurality of physical property values) for the plurality of respective domains with respect to input data (e.g., the predetermined molecular structural formula data, etc.).

In an embodiment, such tasks may include a first task for predicting a first physical property value of a predetermined material, a second task for predicting a second physical property value of the material, . . . , and an n-th task for predicting an n-th (n≥2) physical property value of the material, and each of the tasks described above may include a plurality of sub-tasks for predicting a physical property value mapped to that task.

That is, in an embodiment, the tasks may include a plurality of sub-tasks for predicting the physical property value mapped to the n-th task, and a main-task including the plurality of sub-tasks. In this regard, the main task may correspond to the n-th task mapped thereto.

In addition, the tasks according to an embodiment may include a source task that is a task of an entity providing data transferred in the transfer learning process according to an embodiment of the invention, and a target task that is a task of an entity receiving the transferred data.

In other words, in an embodiment, a task may be defined as a source task or a target task depending on whether the task corresponds to an entity that transfers data during a learning process or an entity that receives transferred data.

In other words, the multi-tasking learning model MtLM that has performed pre-learning according to an embodiment of the invention may receive predetermined intrinsic material characteristic information and/or material physical property-specific information, and output data predicted based on the input information and learned knowledge.

In an embodiment, the multi-tasking learning model MtLM may receive predetermined intrinsic material characteristic information and output material physical property-specific information predicted based on the input information and learned knowledge.

In this regard, according to embodiments, the multi-tasking learning model MtLM may receive predetermined material physical property-specific information, and output intrinsic material characteristic information predicted based on the input information and learned knowledge.

That is, the multi-tasking learning model MtLM may include a model that is reverse-designed to predict and output intrinsic material characteristic information based on predetermined material physical property-specific information.

In addition, according to embodiments, the multi-tasking learning model MtLM may receive predetermined intrinsic material characteristic information and material physical property-specific information, and output optimal intrinsic material characteristic information and material physical property-specific information predicted based on the input information and learned knowledge.

That is, the multi-tasking learning model MtLM may include a model that is reverse-designed to output optimal intrinsic material characteristic information and material physical property-specific information predicted based on predetermined intrinsic material characteristic information and material physical property-specific information.

As described above, in the multi-tasking learning model MtLM according to an embodiment of the invention, in the process of simultaneously learning tasks for predicting a plurality of physical properties of a predetermined material, not only principles between the material and individual physical properties but also relationships between the physical properties and a common principle shared across the learned entire physical properties are learned, thereby enabling more accurate prediction of the physical property values and facilitating updates.

In addition, because training data on a plurality of physical properties are related to various materials, the multi-tasking learning model MtLM may perform learning on materials in a more expanded range, thereby also further expanding a material range predictable for each physical property.

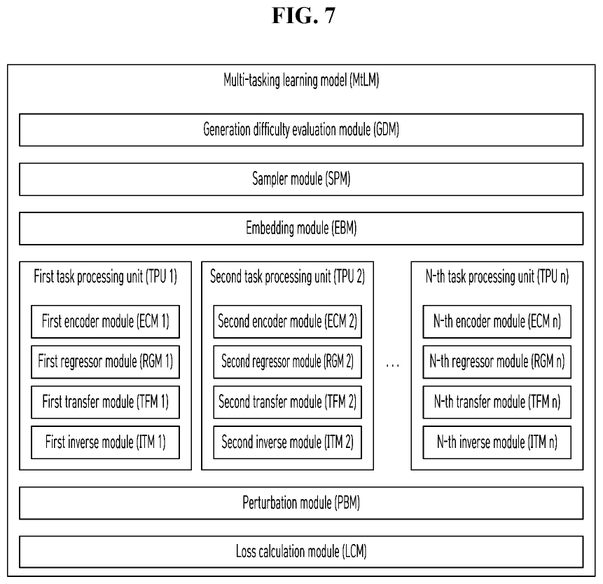

FIG. 7 illustrates an internal block diagram of a multi-tasking learning model MtLM according to an embodiment of the invention.

Referring to FIG. 7, in another aspect, a multi-tasking learning model MtLM according to an embodiment may include at least one embedding module EBM, at least one task processing unit TPU, at least one encoder module ECM, at least one regressor module RGM, at least one transfer module TFM, at least one inverse transfer module ITM, at least one perturbation module PBM, and at least one loss calculation module LCM.

In detail, the embedding module EBM according to an embodiment of the invention may be a pre-encoder module that converts predetermined input data into embedding vectors.

Specifically, the embedding module EBM may compress molecular structural formula data, which is high-dimensional data, into embedding vectors, which are low-dimensional representations, thereby reducing dimensionality of inputs to be processed by an encoder to improve calculation efficiency and learning speed, and enabling the encoder to be trained focusing on important features in the molecular structural formula for pre-learning tasks.

Accordingly, useful features from a model trained on a source task may be easily applied to a model to be trained on a target task, and overlapping features among different domains may be generalized, thereby effectively performing transfer learning for new domains/tasks.

That is, the embedding module EBM may be a module that projects specific input data into a predetermined embedding space and converts the input data into a vector format. In an embodiment, as the embedding module EBM, a graph neural network (GNN) suitable for molecular structural formula feature extraction may be used, and for example, embedding vectors for input data may be provided based on a directed message passing neural network (DMPNN) structure.

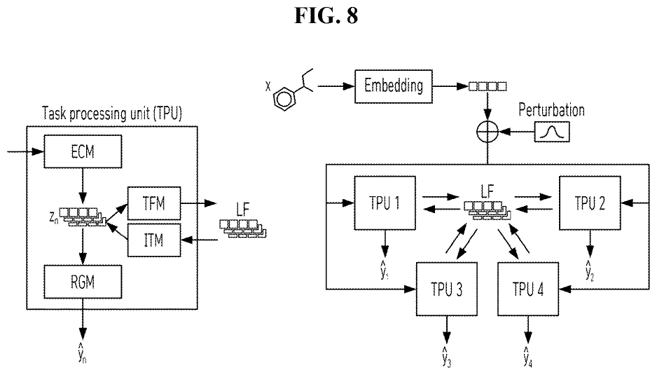

FIG. 8 illustrates an example of a conceptual diagram for describing a multi-tasking learning model MtLM including a plurality of task processing units TPU according to an embodiment of the invention.

In addition, referring to FIG. 8, a task processing unit TPU according to an embodiment of the invention may be a module that performs learning and prediction processes based on predetermined tasks.

In an embodiment, such task processing units TPU may include a first task processing unit corresponding to a first domain (e.g., boiling point), a second task processing unit corresponding to a second domain (e.g., melting point), . . . , and an n-th task processing unit corresponding to an n-th domain.

That is, in an embodiment, the task processing units TPU may include a plurality of first to n-th task processing units TPU corresponding to the number of given domains (i.e., physical properties).

In this regard, in an embodiment, one task processing unit TPU among the plurality of task processing units TPU may be a source task processing unit that is a task processing unit TPU corresponding to a source task of transfer learning according to an embodiment of the invention.

In addition, one task processing unit TPU among the remaining task processing units TPU excluding the source task processing unit may be a target task processing unit that is a task processing unit TPU corresponding to a target task of transfer learning according to an embodiment of the invention.

In detail, the task processing unit TPU according to an embodiment may include at least one encoder module ECM, at least one regressor module RGM, at least one transfer module TFM, and at least one inverse module ITM.

Specifically, the encoder module ECM according to an embodiment of the invention may be a module that receives predetermined embedding vectors as input, projects the input embedding vectors into a latent space corresponding to a corresponding task, and converts the same into latent vectors.

That is, the encoder module ECM may be a module that extracts main features of the input embedding vectors and represents the main features in a corresponding latent space. In detail, the encoder module ECM may extract important features among features of the embedding vectors, and may perform data compression by progressively compressing the data into a lower-dimensional space while removing unnecessary information or noise, thereby outputting the data as latent vectors that are representations in a latent space.

In an embodiment, such encoder modules ECM may include a plurality of encoder modules ECM respectively corresponding to a plurality of domains.

In an embodiment, the encoder modules ECM may include a first encoder module corresponding to a first domain (e.g., boiling point), a second encoder module corresponding to a second domain (e.g., melting point), . . . , and an n-th encoder module corresponding to an n-th domain.

In another embodiment, the encoder modules ECM may include a third encoder module for performing a first task of predicting solubility in a first solvent corresponding to a third domain (e.g., solubility), and a fourth encoder module for performing a second task of predicting solubility in a second solvent. That is, in another embodiment, multi-tasking may be performed for different tasks for within the same domain. In one example, a multi-tasking model that integrates multi-tasking across different domains and multi-tasking for different tasks within the same domain may also be included as an embodiment of the invention.

Hereinafter, the description will be made based on an assumption that different domains correspond to different tasks.

In this regard, in an embodiment, one encoder module ECM among the plurality of encoder modules ECM may be a source encoder module that is an encoder module ECM corresponding to a source task of transfer learning according to an embodiment of the invention.

In addition, one encoder module ECM among the remaining encoder modules ECM excluding the source encoder module may be a target encoder module that is an encoder module ECM corresponding to a target task of transfer learning according to an embodiment of the invention.

In addition, the regressor module RGM according to an embodiment of the invention may be a head module that receives predetermined latent vectors as input and generates a final prediction value according to the input latent vectors. That is, in an embodiment, the regressor module RGM is used as an example of the head module.

Such a regressor module RGM may be directly involved in generating the final output to determine the prediction performance of the model.

In addition, in an embodiment, the regressor modules RGM may include a plurality of regressor modules RGM respectively corresponding to a plurality of domains.

In an embodiment, the regressor modules RGM may include a first regressor module corresponding to a first domain (e.g., boiling point), a second regressor module corresponding to a second domain (e.g., melting point), . . . , and an n-th regressor module corresponding to an n-th domain.

In this regard, in an embodiment, one regressor module RGM among the plurality of regressor modules RGM may be a source regressor module that is a regressor module RGM corresponding to a source task of transfer learning according to an embodiment of the invention.

In addition, one regressor module RGM among the remaining regressor modules RGM excluding the source regressor module may be a target regressor module that is a regressor module RGM corresponding to a target task of transfer learning according to an embodiment of the invention.

In addition, the transfer module TFM according to an embodiment of the invention may be a module that maps predetermined latent vectors to a latent space of another task and converts the mapped latent vectors into transfer vectors.

In detail, in an embodiment, the transfer module TFM may map specific latent vectors to a latent space of another task through the integrated latent space M based on Riemannian geometry and convert the mapped latent vectors into transfer vectors.

In this process, the transfer module TFM may implement geometric alignment among the mapped tasks according to an embodiment of the invention. This will be described later in detail in the following multi-tasking model training method.

That is, in an embodiment, the transfer module TFM may implement knowledge transfer by performing geometric alignment between mapped tasks during the process of mapping specific latent vectors to a latent space of another task through the integrated latent space M, which is realized as a universal local flat (LF) space. A detailed description thereof will be provided later in the following multi-tasking model training method.

That is, in an embodiment, the transfer module TFM may effectively perform a transfer of knowledge data among a plurality of tasks by mapping latent vectors according to a first task to a latent space according to a second task through geometric alignment according to an embodiment of the invention.

In this regard, in an embodiment, the transfer module TFM may support data processing that improves the accuracy and consistency of the converted vector (i.e., the transfer vector) by utilizing an autoencoder structure.

In addition, in an embodiment, the transfer modules TFM may include a plurality of transfer modules TFM respectively corresponding to a plurality of domains.

In an embodiment, the transfer modules TFM may include a first transfer module corresponding to a first domain (e.g., boiling point), a second transfer module corresponding to a second domain (e.g., melting point), . . . , and an n-th transfer module corresponding to an n-th domain.

In this regard, in an embodiment, one transfer module TFM among the plurality of transfer modules TFM may be a source transfer module that is a transfer module TFM corresponding to a source task of transfer learning according to an embodiment of the invention.

In addition, one transfer module TFM among the remaining transfer modules TFM excluding the source transfer module may be a target transfer module that is a transfer module TFM corresponding to a target task of transfer learning according to an embodiment of the invention.

In addition, the inverse transfer module ITM according to an embodiment of the invention may be a module that reconstructs the transfer vectors mapped and converted into the latent space of another task by the transfer module TFM so as to be mapped back to the original latent space.

Thus, in an embodiment, the inverse module ITM may generate vectors (hereinafter, inverse vectors) obtained by reconstructing and converting the transfer vectors back to its original state.

In this regard, in an embodiment, the inverse module ITM may improve the stability of the above-described reconstruction process and the accuracy and consistency of the corresponding transfer vectors by utilizing the autoencoder structure.

In an embodiment, such inverse modules ITM may include a plurality of inverse modules ITM respectively corresponding to a plurality of domains.

In an embodiment, the inverse modules ITM may include a first inverse module corresponding to a first domain (e.g., boiling point), a second inverse module corresponding to a second domain (e.g., melting point), . . . , and an n-th inverse module corresponding to an n-th domain.

In this regard, in an embodiment, one inverse module ITM among the plurality of inverse modules ITM may be a source inverse module that is an inverse module ITM corresponding to a source task of transfer learning according to an embodiment of the invention.

In addition, one inverse module ITM among the remaining inverse modules ITM excluding the source inverse module may be a target inverse module that is an inverse module ITM corresponding to a target task of transfer learning according to an embodiment of the invention.

As such, in an embodiment, the multi-tasking learning model MtLM includes the plurality of task processing units TPU respectively corresponding to the plurality of domains (i.e., physical properties), thereby defining latent spaces for the respective plurality of tasks performed based thereon.

In addition, the multi-tasking learning model MtLM may simultaneously learn a transformation in which the plurality of defined latent spaces are transformed into one integrated latent space M according to a pre-training method to be described later.

In other words, the multi-tasking learning model MtLM may perform learning for geometrically aligning n latent spaces according to various physical properties into one integrated latent space M according to the pre-training method to be described below through the plurality of task processing units TPU.

Therefore, the multi-tasking learning model MtLM may implement simultaneous/collective transfer learning for n*n physical property combinations when considering n physical properties.

Therefore, the multi-tasking learning model MtLM according to an embodiment may improve the prediction performance according to information sharing and learning among interrelated physical properties/tasks.

In this regard, in an embodiment, the multi-tasking learning model MtLM may implement the transformation between the plurality of latent spaces and the integrated latent space M in the same manner regardless of configurations of physical property combinations (e.g., the first task-second task combination or the second task-third task combination).

In other words, the multi-tasking learning model MtLM may perform the transformation between latent spaces of the multi-tasks corresponding to various physical properties and the integrated latent space M in the same manner.

Accordingly, the multi-tasking learning model MtLM may implement data processing of aligning geometric characteristics based on respective latent vectors for a plurality of latent spaces on the integrated latent space M in the same manner.

Therefore, the multi-tasking learning model MtLM may effectively maintain the consistency of the transformation from each latent space to the integrated latent space M. Thus, the multi-tasking learning model MtLM may more stably support flow of information among tasks.

For example, when the transformation from the latent space of the first task to the integrated latent space M and the transformation from the latent space of the second task to the integrated latent space M are the same as each other, the multi-tasking learning model MtLM may usefully utilize information obtained from the first task for the second task.

Therefore, the multi-tasking learning model MtLM may enhance the sharing of knowledge data among multi-tasks, and at the same time, may further improve the prediction performance and stability of the model.

Referring back to FIG. 7, a perturbation module PBM according to an embodiment of the invention may be a module that generates a plurality of perturbation vectors by applying predetermined changes to predetermined embedding vectors.

In detail, in an embodiment, the perturbation module PBM may be a module that applies a change of moving specific embedding vectors in a predetermined direction, thereby generating a plurality of perturbation vectors (i.e., perturbation points) on a periphery of the corresponding embedding vectors.

In this regard, the plurality of generated perturbation vectors may be designed to maintain relative distances to the corresponding embedding vectors, thereby effectively assisting geometric alignment.

That is, the above-described perturbation module PBM may generate a plurality of perturbation vectors to assist geometric alignment of the model, thereby helping to align coordinate systems between a source task and a target task.

In addition, in an embodiment, the perturbation module PBM may calculate distances between predetermined embedding vectors and a plurality of perturbation vectors generated based thereon, and may support alignment of displacements between a source task and a target task based on the calculated distances.

Accordingly, the perturbation module PBM may more easily maintain consistency in the latent space for the model.

According to an embodiment, the perturbation module PBM may force to maintain relationships between predetermined embedding vectors and a plurality of perturbation vectors generated based thereon, thereby preventing overfitting of a model and improving generalization performance.

In addition, a loss calculation module LCM according to an embodiment of the invention may be a module that calculates various loss functions based on various vectors obtained through the multi-tasking learning model MtLM.

In an embodiment, the loss calculation module LCM may calculate a regression loss, an autoencoder loss, a consistency loss, a mapping loss, a distance loss, and/or an integrated loss according to an embodiment of the invention. This will be described later in detail in the following multi-tasking model training method.

Accordingly, the loss calculation module LCM may support normalization and training for different parts of a model, and may provide feedback for model training to implement model optimization.

In one example, in an embodiment of the invention, the multi-tasking learning model MtLM may perform model optimization and update through various data processing processes in association with the above-described modules.

As an example, the multi-tasking learning model MtLM may perform model optimization and parameter update by interoperating with the above-described modules based on an AdamW optimization algorithm or the like.

As described above, in an embodiment of the invention, the multi-tasking learning model MtLM may not only learn knowledge data corresponding to various domains at the same time but also efficiently learn relationships among various domains, thereby performing effective multi-tasking learning that expands a learning area and simultaneously implements collective learning of a local pattern corresponding to each domain and a common principle shared across the plurality of domains.

Accordingly, the multi-tasking learning model MtLM may directly improve the processing performance and accuracy of various multi-tasking tasks based on the models trained as described above.

### [Multi-Tasking Model Pre-Training Method]

Hereinafter, a method by which the computing system 1000 according to an embodiment of the invention performs multi-tasking model pre-training of performing transfer learning through geometric alignment in an integrated latent space for multi-tasks corresponding to a plurality of domains will be described in detail.

In general, existing transfer learning techniques are mainly focused on classifying image and/or language data sets, and have limitations in addressing regression problems or problems in non-Euclidean spaces.

In particular, when the training data set is insufficient, the degradation of the prediction performance for the above-described problems becomes even more inevitable, and when multi-tasking considering various task types is also required, the degradation of the performance in training and prediction therefor is further exacerbated.

In addition, because most of the existing methods are optimized for handling data in Euclidean spaces, they do not operate effectively in complex curved spaces or non-linear spaces.

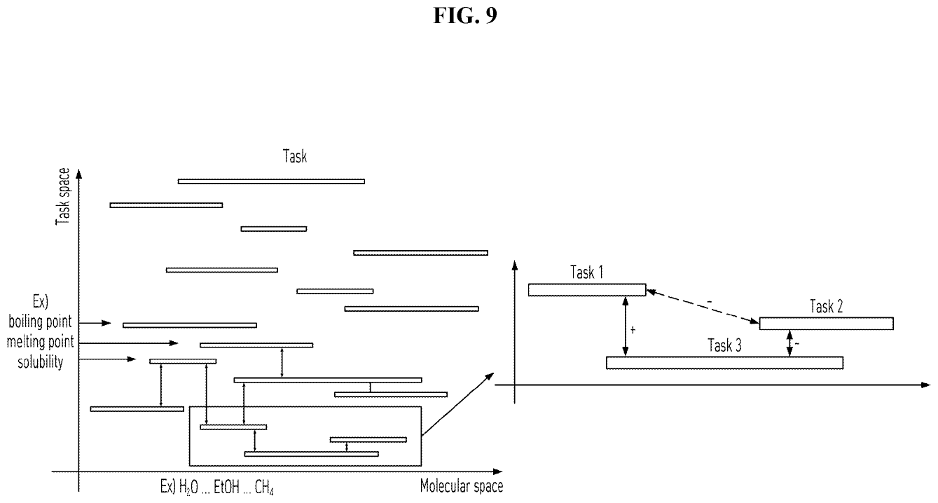

FIG. 9 illustrates an example of a conceptual diagram for describing a multi-tasking model pre-training method according to an embodiment of the invention.

Accordingly, as shown in FIG. 9, the computing system 1000 according to an embodiment of the invention is intended to provide a new multi-tasking model pre-training method capable of overcoming the regression problems of small-scale data sets and the limitations of the existing transfer learning techniques.

Hereinafter, in the description according to an embodiment of the invention, for the sake of effective description, the above-described material will be limited to “molecules”, and domains thereof will be described based on “physical properties”.

This takes into account that molecular data sets generally have limited data, include various task types, and mainly deal with regression problems.

That is, in the case of a molecular data set, various task processing associated with numerous physical properties is required, but data given therefor are very limited, and the physical properties are closely related to or influenced by each other.

In consideration of these, a molecular data set may be data advantageous to be applied to multi-task processing according to a plurality of domains, and may be a preferred example for the description of the multi-tasking model pre-training method according to an embodiment of the invention.

However, the inventive concepts are not limited thereto, and it is obvious that any embodiment in which multi-tasks across multiple domains are applicable may be included within the scope of the inventive concepts.

Hereinafter, a method for pre-training a multi-tasking model according to an embodiment of the invention will be described in more detail with reference to the accompanying drawings.

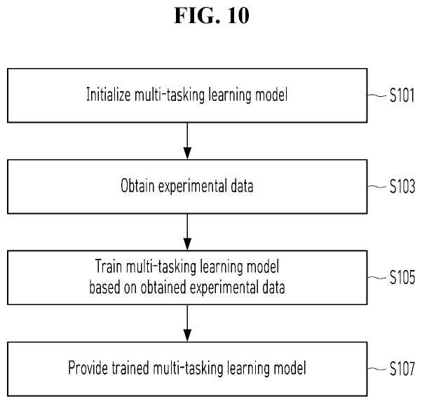

FIG. 10 is a flowchart for illustrating a multi-tasking model pre-training method according to an embodiment of the invention.

Referring to FIG. 10, the multi-tasking model pre-training method according to an embodiment of the invention may include initializing the multi-tasking learning model MtLM (S101), obtaining experimental data (S103), training the multi-tasking learning model MtLM based on the obtained experimental data (S105), and providing the trained multi-tasking learning model MtLM (S107).

In detail, the computing system 1000 according to an embodiment of the invention may initialize the multi-tasking learning model MtLM (S101).

Here, in other words, the multi-tasking learning model MtLM (geometrically aligned transfer encoder model) according to an embodiment of the invention may be a machine learning model in which knowledge data (e.g., a latent vector, etc.) fragmented in latent spaces for respective tasks are mutually aligned in a single integrated latent space M (manifold) through a geometric transfer in order to process multi-tasks for outputs according to a plurality of domains.

That is, the multi-tasking learning model MtLM according to an embodiment may not only learn knowledge data corresponding to various domains at the same time but also efficiently learn relationships among various domains, thereby performing effective multi-tasking learning that expands a learning area and simultaneously implements collective learning of a local pattern corresponding to each domain and a common principle shared across the plurality of domains.

In detail, in an embodiment, the computing system 1000 may perform initialization on each component included in the multi-tasking learning model MtLM as described above.

In an embodiment, the computing system 1000 may initialize an embedding network embedd(X), an encoder network fₑ, a regressor (head) network fₕ, a transfer network fₜ, and/or an inverse network fₜ within the multi-tasking learning model MtLM with random parameters θ.

In addition, in an embodiment, the computing system 1000 may set a predetermined optimization algorithm to be applied to the multi-tasking learning model MtLM.

For example, the computing system 1000 may set a decoupled weight decay regularization (AdamW) algorithm as the optimization algorithm, and may improve and use the optimization algorithm to independently process a weight decay according to embodiments.

In addition, the computing system 1000 according to an embodiment of the invention may obtain the experimental data (S103).

Here, in other words, experimental data x according to an embodiment of the invention may be training data used for training of the multi-tasking learning model MtLM, may include predetermined input data and output data (i.e., label) information corresponding thereto.

In an embodiment, such experimental data may be data including predetermined intrinsic material characteristic information and material physical property-specific information corresponding thereto. That is, in an embodiment, the experimental data may be data in which predetermined intrinsic material characteristic information is used as input data, and material physical property-specific information is included as output data (i.e., label) mapped to the input intrinsic material characteristic information.

In this regard, the intrinsic material characteristic information according to an embodiment may be information specifying unique characteristics possessed by a predetermined material. That is, in an embodiment, the intrinsic material characteristic information may be information specifying unique characteristics possessed by predetermined molecules.

For example, the intrinsic material characteristic information may include at least one of a predetermined material name, a molecular structural formula, and/or chemical formula data. In the following description, the intrinsic material characteristic information is limited to molecular structural formula (e.g., n-dimensional (n≥2) molecular structural formula) data.

In addition, the material physical property-specific information according to an embodiment may be information specifying data values (i.e., characteristic values of physical properties, where the values include ranges) that a predetermined material has with respect to predetermined physical properties.

For example, the material physical property-specific information may include physical property (i.e., domain) values such as boiling point, melting point, refractive index, solubility, viscosity, surface tension, density, strength, and/or thermal conductivity of a predetermined material.

In other words, in the following embodiment, molecular structural formula data indicating the intrinsic material characteristic information will be used as input data, and physical property value data for each task will be used as output data.

In detail, in an embodiment, the computing system 1000 may obtain the experimental data as described above based on predetermined user input and/or association with an external server.

In more detail, in an embodiment, the computing system 1000 may obtain physical property relationship data indicating relationships among predetermined physical properties.

Specifically, in an embodiment, the computing system 1000 may obtain the physical property relationship data based on user input (e.g., an input of data manually collected by a user) and/or association with a predetermined artificial intelligence model.

In an embodiment, the computing system 1000 may obtain the physical property relationship data based on prompt engineering in association with a predetermined pre-trained large language model.

In detail, the computing system 1000 may perform data searches according to keywords for physical properties from a database of predetermined professional materials (e.g., papers, patents, and/or academic data) through a specific large language model.

In addition, the computing system 1000 may extract at least one piece of information indicating relationships among predetermined physical properties from the searched data.

In addition, the computing system 1000 may perform an editing process of classifying, characterizing, and organizing the extracted physical property relationship information according to criteria such as a physical property type and/or a relationship type.

Accordingly, the computing system 1000 may obtain physical property relationship data based on the edited information.

In addition, in an embodiment, the computing system 1000 may database the obtained physical property relationship data.

In detail, the computing system 1000 according to an embodiment may include a physical property relationship data database.

Here, the above-described physical property relationship data database may store data including information on relationships among predetermined physical properties.

Such a physical property relationship data database may store data manually collected by a person, or may store data automatically searched, extracted, and edited through a pre-trained artificial intelligence model.

That is, in an embodiment, the computing system 1000 may store and manage the physical property relationship data obtained as described above in the physical property relationship data database.

Therefore, the computing system 1000 may construct the physical property relationship data database including the information on the relationships among various physical properties.

Thereafter, in an embodiment, the computing system 1000 may obtain physical property relationship information specifying relationships among different physical properties, based on the physical property relationship data included in the physical property relationship data database.

In an embodiment, the computing system 1000 may obtain at least one piece of physical property relationship information according to predetermined physical property relationship data by interoperating with a predetermined pre-trained large language model.

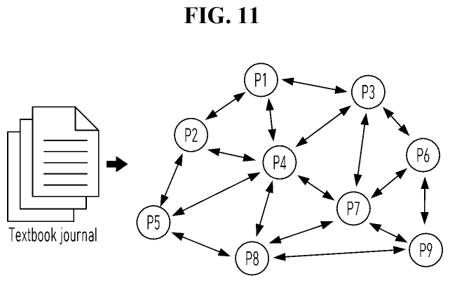

FIG. 11 illustrates an example of a knowledge graph showing relationships among physical properties according to an embodiment of the invention.

For example, referring to FIG. 11, the computing system 1000 may obtain a predetermined knowledge graph as the physical property relationship information, and in this case, the knowledge graph may include relationship information among first to n-th physical properties including relationship information between a first physical property P1 and a second physical property P2, relationship information between the first physical property P1 and a third physical property P3, and the like.

As a specific example, the physical property relationship information as described above may include information on physical properties associated with a specific physical property, information on attributes of relationships (e.g., conflicting, similar, correlated, cause-and-effect, independent, proportional, and/or inversely related relationships), and/or information on a degree of association (association strength) according to the determined relationship attributes.

Here, the attributes of relationships (hereinafter, physical property relationship attributes) and the degree of association information according to an embodiment may be indicated on the knowledge graph by being distinguished into numerical values indicating associations in a positive correlation and numerical values indicating associations in a negative correlation.

In addition, in an embodiment, the computing system 1000 may obtain the above-described experimental data based on the obtained physical property relationship information.

That is, in an embodiment, the computing system 1000 may obtain the experimental data including predetermined intrinsic material characteristic information and material physical property-specific information corresponding thereto based on the various physical property relationship information obtained as described above.

In an embodiment, the computing system 1000 may obtain at least one experimental data according to predetermined physical property relationship information by interoperating with a predetermined pre-trained large language model.

It has been described that the computing system 1000 obtains the experimental data through predetermined data pre-processing based on the given physical property relationship information, but this is only an example, and various embodiments are available, such as using the given physical property relationship information itself as the experimental data.

As a specific example, the computing system 1000 may obtain first experimental data including information on a first physical property with respect to molecular structural formulas of a plurality of materials, second experimental data including information on a second physical property with respect to molecular structural formulas of a plurality of materials, and the like.

Here, a plurality of materials corresponding to the first experimental data and a plurality of materials corresponding to the second experimental data may be different from each other, or may be at least partially the same as each other.

As such, in an embodiment, the computing system 1000 may obtain the above-described experimental data based on physical property relationship information collected from various data sources, thereby implementing model training using more abundant training data and minimizing errors due to data bias and data shortage.

Accordingly, the computing system 1000 may maximize effects of the various data sources to support the trained model to perform more accurate and reliable prediction, and may directly improve multi-task processing and prediction performance for a plurality of physical properties.

In this regard, in an embodiment of the invention, the computing system 1000 may reflect the physical property relationship information (e.g., the degree of association information, etc.) obtained as described above in weights for at least one of various losses used during training of the multi-tasking learning model MtLM in step S205 to be described below.

That is, in an embodiment, the computing system 1000 may perform effective multi-tasking learning that implements collective learning of a local pattern for each domain (i.e., physical property) and a common principle shared across a plurality of domains by reflecting physical property relationship information specifying relationships among various physical properties.

In one example, according to embodiments, when the relationship between the predetermined first physical property and the predetermined second physical property is represented as a mathematical formula in the physical property relationship data database, the computing system 1000 may detect the same.

In addition, the computing system 1000 may augment an experimental data set for training the multi-tasking learning model MtLM using the detected mathematical formula.

As an example, the computing system 1000 may expand a data set in which only the first physical property exists for a predetermined material into a data set that further considers a second physical property by applying data augmentation based on the detected mathematical formula.

Alternatively, the computing system 1000 may optimize and update the multi-tasking learning model MtLM using the detected mathematical formula as described above according to embodiments.

For example, when the multi-tasking learning model MtLM has learned only the first physical property between the first physical property and the second physical property, the computing system 1000 may update the multi-tasking learning model MtLM to predict the second physical property by applying the detected mathematical formula to the first physical property.

Alternatively, the computing system 1000 may improve integrated latent space M mapping accuracy during transfer learning of the multi-tasking learning model MtLM using the detected mathematical formula according to embodiments.

For example, when the multi-tasking learning model MtLM has learned both of two tasks for predicting the first physical property and the second physical property, the computing system 1000 may re-perform transfer learning between a model for the task of predicting the first physical property and a model for the task of predicting the second physical property based on the detected mathematical formula. Accordingly, the computing system 1000 may improve integrated latent space M mapping optimization of the multi-tasking learning model MtLM, thereby improving accuracy thereof.

In addition, the computing system 1000 according to an embodiment of the invention may train the multi-tasking learning model MtLM based on the obtained experimental data (S105).

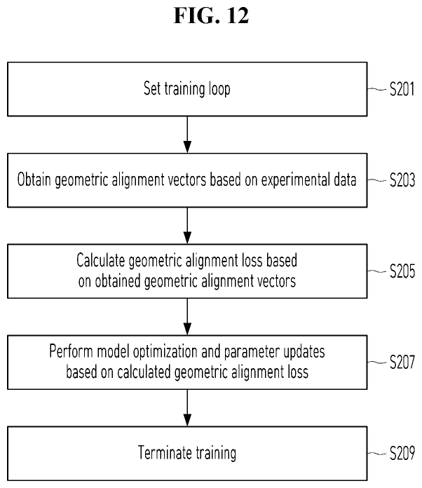

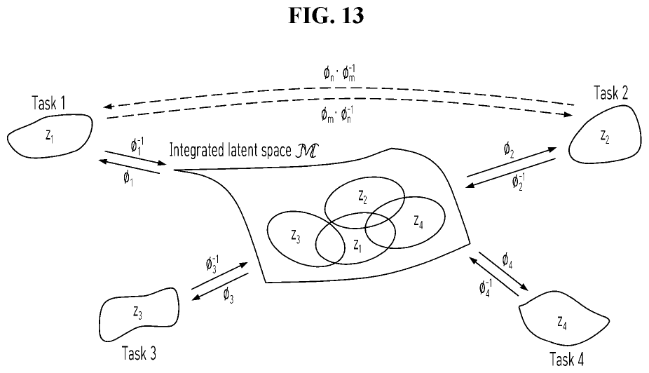

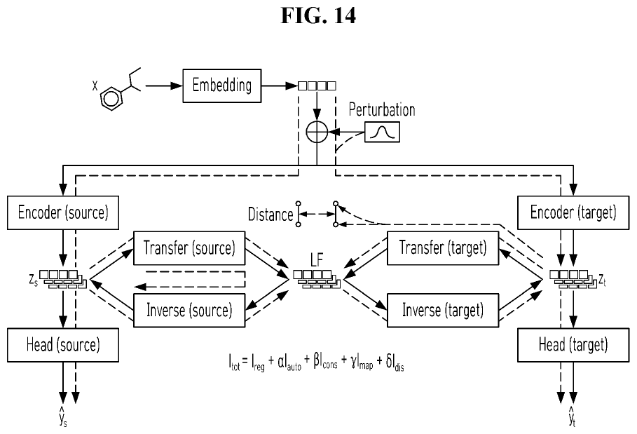

FIG. 12 is a flowchart for describing a multi-tasking learning model MtLM training method according to an embodiment of the invention. FIG. 13 illustrates an example of a first conceptual diagram for describing a multi-tasking learning model MtLM training method according to an embodiment of the invention. FIG. 14 illustrates an example of a second conceptual diagram for describing a multi-tasking learning model MtLM training method according to an embodiment of the invention.

That is, referring to FIGS. 12 to 14, in an embodiment, the computing system 1000 may perform pre-training of the multi-tasking learning model MtLM based on the experimental data obtained as described above.

In this regard, in an embodiment, the computing system 1000 may allow the multi-tasking learning model MtLM to simultaneously learn multi-tasks for predicting at least two domains (i.e., physical properties).

In detail, in an embodiment, when the first task for performing prediction on the first physical property is referred to as a source task and the n-th task for performing prediction on the n-th (n≥2) physical property is referred to as a target task, the computing system 1000 may collectively perform transfer learning-based pre-training on the source task and the target task, and the reverse may also be performed in the same manner.

In other words, in an embodiment, when considering n physical properties, the computing system 1000 may simultaneously perform multiple transfer learning processes corresponding to n*n combinations among the first to n-th physical properties based on the multi-tasking learning model MtLM.

Accordingly, the computing system 1000 according to an embodiment of the invention may allow the multi-tasking learning model MtLM to naturally learn correlations among physical properties learned together while learning the plurality of physical properties through transfer learning, thereby enabling more accurate prediction for each physical property.

As a specific example, the computing system 1000 may pre-train the multi-tasking learning model MtLM to learn relationships among the first to third physical properties based on experimental data including relationship information among the predetermined first to third physical properties. Thereafter, the computing system 1000 may more accurately predict relationship information among the first to third physical properties for a first material having only relationship information for the first and second physical properties using the multi-tasking learning model MtLM pre-trained as described above.

In addition, accordingly, when experimental data for each physical property includes data of different molecular structure types, the computing system 1000 may train the multi-tasking learning model MtLM for various molecular structure types through transfer learning, thereby implementing task processing that operates robustly against variations in molecular structures and provides accurate prediction values for physical properties.

That is, the computing system 1000 according to an embodiment may perform pre-training that collectively trains the multi-tasking learning model MtLM on not only various physical property data but also relationships among various physical properties, thereby implementing effective multi-tasking learning that expands a model learning area and implements simultaneous/collective learning of a local pattern according to each physical property and a common principle shared across a plurality of physical properties.

Accordingly, the computing system 1000 may significantly improve processing performance and quality of various multi-tasking tasks based on the multi-tasking learning model MtLM pre-trained as described above, thereby expanding a range in which accurate prediction is available.

Returning to the description, in an embodiment, the computing system 1000 may perform the transfer learning-based pre-training as described above according to the following processes.

In detail, in an embodiment, the computing system 1000 may set a training loop for the multi-tasking learning model MtLM (S201).

In more detail, in an embodiment, the computing system 1000 may set the number of repetitions of epochs, tasks, and/or batches during training.

In an embodiment, the computing system 1000 may set a training loop to repeat training for epochs “i” from 1 to n (n≥1), to repeat training over each task “t”, and to repeat training over each preset batch “b”.

In addition, in an embodiment, the computing system 1000 may obtain geometric alignment vectors based on the experimental data obtained, as described above (S203).

Here, the geometric alignment vectors according to an embodiment of the invention may refer to various vectors obtained through the multi-tasking learning model MtLM.

In an embodiment, the geometric alignment vectors may include embedding vectors, perturbation vectors, encoding vectors, transfer vectors, inverse vectors, and the like.

In detail, in an embodiment, the computing system 1000 may input the obtained experimental data to the multi-tasking learning model MtLM.

In addition, in an embodiment, the computing system 1000 may obtain 1) embedding vectors based on the multi-tasking learning model MtLM to which the experimental data is input.

In more detail, the computing system 1000 may convert the input experimental data into the embedding vectors through an embedding network by interoperating with the embedding module EBM of the multi-tasking learning model MtLM.

Accordingly, the computing system 1000 may obtain the embedding vectors converted into a vector format by projecting the experimental data into a predetermined embedding space.

In addition, in an embodiment, the computing system 1000 may generate 2) perturbation vectors based on the obtained embedding vectors.

In detail, in an embodiment, the computing system 1000 may generate a plurality of perturbation vectors (i.e., perturbation points) on a predetermined periphery of the obtained embedding vectors by interoperating with the perturbation module PBM of the multi-tasking learning model MtLM.

In this regard, in an embodiment, the computing system 1000 may repeatedly perform the above-described functional operation for each task to obtain perturbation vectors corresponding to each task.

In an embodiment, the computing system 1000 may obtain a plurality of task-specific perturbation vectors including a perturbation vector corresponding to a task “t” and a perturbation vector corresponding to a task “s”.

In addition, in an embodiment, the computing system 1000 may obtain encoding vectors, transfer vectors, and inverse vectors based on the generated perturbation vectors and embedding vectors.

In detail, referring to FIGS. 8, 13, and 14, in an embodiment, the computing system 1000 may obtain encoding vectors, transfer vectors, and inverse vectors for each task processing unit TPU by collectively interoperating with a plurality of task processing units TPU included in the multi-tasking learning model MtLM.

That is, the computing system 1000 may obtain encoding vectors, transfer vectors, and inverse vectors for each of a plurality of tasks processed by each task processing unit TPU by collectively interoperating with a plurality of task processing units TPU respectively corresponding to a plurality of physical properties (i.e., domains) to be predicted.

Hereinafter, for the sake of effective description, a method of obtaining the vectors based on the task “t” processed by the first task processing unit TPU and the task “s” processed by the second task processing unit TPU will be described. However, all of the plurality of task processing units TPU described above may obtain the vectors for each of the plurality of tasks corresponding to each unit in the same manner as described below.

In detail, in an embodiment, the computing system 1000 may obtain 3) encoding vectors based on the generated perturbation vectors and embedding vectors.

Here, the encoding vectors according to an embodiment may include perturbation latent vectors that are latent vectors generated based on predetermined perturbation vectors, and original latent vectors generated based on embedding vectors that are original vectors of the perturbation vectors.

In more detail, in an embodiment, the computing system 1000 may project the generated perturbation vectors into a latent space corresponding to a corresponding task through the encoder network and convert the resultant perturbation vectors into latent vectors by interoperating with the encoder modules ECM included in the first and second task processing units TPU (hereinafter, training task processing units) of the multi-tasking learning model MtLM.

In addition, in an embodiment, the computing system 1000 may project the obtained embedding vectors to a latent space corresponding to the task through the encoder network and convert the resultant embedding vectors into latent vectors by interoperating with the encoder module ECM of the multi-tasking learning model MtLM.

Accordingly, in an embodiment, the computing system 1000 may obtain the perturbation latent vectors and the original latent vectors.

In this regard, in an embodiment, the computing system 1000 may repeatedly perform the above-described functional operation for each task to obtain the original latent vectors and the perturbation latent vectors corresponding to each task.

In an embodiment, the computing system 1000 may obtain an original latent vector (hereinafter, a t-th original latent vector) corresponding to the task “t” and a perturbation latent vector (hereinafter, a t-th perturbation latent vector) corresponding to the task “t”.

In addition, the computing system 1000 may obtain an original latent vector (hereinafter, an s-th original latent vector) corresponding to the task “s” and a perturbation latent vector (hereinafter, an s-th perturbation latent vector) corresponding to the task “s”.

In addition, in an embodiment, the computing system 1000 may obtain 4) transfer vectors based on the obtained encoding vectors.

Here, the transfer vector according to an embodiment may include perturbation transfer vectors that are transfer vectors generated based on predetermined perturbation latent vectors, and original transfer vectors that are transfer vectors generated based on original latent vectors corresponding to the perturbation latent vectors.

In detail, in an embodiment, the computing system 1000 may map the obtained perturbation latent vectors and original latent vectors to a latent space of another task (e.g., the task “s” or the task “t”) through a transfer network and convert the mapped result into transfer vectors by interworking with the transfer module TFM included in the training task processing unit of the multi-tasking learning model MtLM.

Accordingly, the computing system 1000 may obtain the perturbation transfer vectors and the original transfer vectors.

In this regard, in an embodiment, the computing system 1000 may repeatedly perform the above-described functional operation for each task to obtain the original transfer vectors and the perturbation transfer vectors corresponding to each task.

In an embodiment, the computing system 1000 may obtain an original transfer vector (hereinafter, a t-th original transfer vector) corresponding to the task “t” and a perturbation transfer vector (hereinafter, a t-th perturbation transfer vector) corresponding to the task “t”.

Further, the computing system 1000 may obtain an original transfer vector (hereinafter, an s-th original transfer vector) corresponding to the task “s” and a perturbation transfer vector (hereinafter, an s-th perturbation transfer vector) corresponding to the task “s”.

Therefore, in an embodiment, the computing system 1000 may obtain experimental data-based geometric alignment vectors (i.e., embedding vectors, perturbation vectors, encoding vectors (including original latent vectors and perturbation latent vectors), and transfer vectors (including original transfer vectors and perturbation transfer vectors).

In addition, in an embodiment, the computing system 1000 may obtain 5) inverse vectors based on the obtained transfer vectors.

Here, the inverse vectors according to an embodiment may include perturbation inverse vectors that are inverse vectors generated based on predetermined perturbation transfer vectors, and original inverse vectors that are inverse vectors generated based on original transfer vectors corresponding to the perturbation transfer vectors.

In detail, in an embodiment, the computing system 1000 may reconstruct the obtained perturbation transfer vectors and original transfer vectors through an inverse network so as to be mapped back to an original latent space and convert the reconstructed vectors into inverse vectors by interoperating with the inverse module ITM included in the training task processing unit of the multi-tasking learning model MtLM.

Therefore, the computing system 1000 may obtain the perturbation inverse vectors and the original inverse vectors.

In this regard, in an embodiment, the computing system 1000 may repeatedly perform the above-described functional operation for each task to obtain original inverse vectors and perturbation inverse vectors corresponding to each task.

In an embodiment, the computing system 1000 may obtain an original inverse vector (hereinafter, a t-th original inverse vector) corresponding to the task “t” and a perturbation inverse vector (hereinafter, a t-th perturbation inverse vector) corresponding to the task “t”.

In addition, the computing system 1000 may obtain an original inverse vector (hereinafter, an s-th original inverse vector) corresponding to the task “s” and a perturbation inverse vector (hereinafter, an s-th perturbation inverse vector) corresponding to the task “s”.

Therefore, in an embodiment, the computing system 1000 may obtain experimental data-based geometric alignment vectors (i.e., embedding vectors, perturbation vectors, encoding vectors (including original latent vectors and perturbation latent vectors), transfer vectors (including original transfer vectors and perturbation transfer vectors), and inverse vectors (including original inverse vectors and perturbation inverse vectors).

Further, in an embodiment, the computing system 1000 may calculate a geometric alignment loss based on the obtained geometric alignment vectors (S205).

Here, the geometric alignment loss according to an embodiment of the invention may refer to various loss functions (Loss) calculated based on various vectors (i.e., geometric alignment vectors) obtained through the multi-tasking learning model MtLM.

In an embodiment, the geometric alignment loss may include a regression loss, an autoencoder loss, a consistency loss, a mapping loss, a distance loss, and/or an integrated loss.

In detail, in an embodiment, the computing system 1000 may calculate the geometric alignment loss based on the geometric alignment vectors obtained as described above (i.e., the geometric alignment vectors corresponding to a plurality of task processing units TPU and to a plurality of tasks processed by the task processing units TPU).

As described above, for the sake of effective description, a method of calculating the geometric alignment loss will be described below based on the task “t” processed by the first task processing unit TPU and the task “s” processed by the second task processing unit TPU (with particular emphasis on the task “t”).

In this regard, in an embodiment, the computing system 1000 may train the multi-tasking learning model MtLM by reflecting the physical property relationship information described in operation S103 described above in weights for at least one loss among various losses included in the geometric alignment loss.

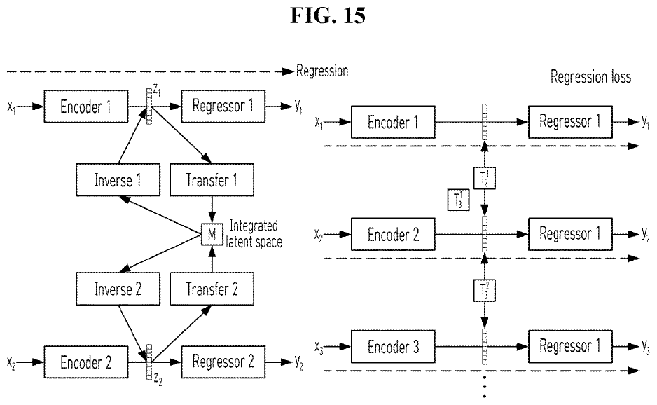

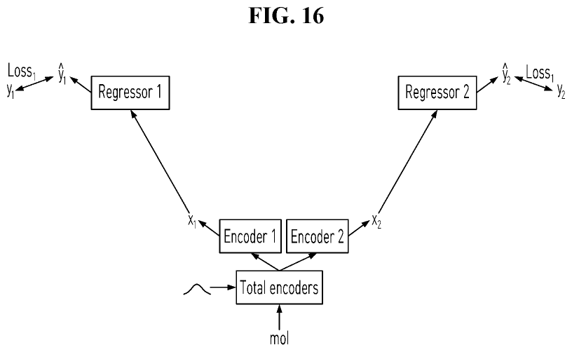

FIGS. 15 and 16 illustrate examples of diagrams for describing a regression loss calculation method according to an embodiment of the invention.

In more detail, referring to FIGS. 14 to 16, in an embodiment, the computing system 1000 may calculate 1) a regression loss based on the multi-tasking learning model MtLM that has obtained the geometric alignment vectors.

In more detail, in an embodiment, the computing system 1000 may calculate a regression loss based on a predicted value predicted through the regressor module RGM and an actual value (i.e., a label value) according to the following [Mathematical formula 1].

$$\begin{matrix}[ Mathematical formula 1 ] & \\ {L}_{reg} = MSE ( \text{?} , {y}_{\text{?}} ) & \end{matrix}$$

$$\text{?} \text{indicates text missing or illegible when filed}$$

That is, the computing system 1000 may calculate the regression loss by calculating a mean squared error (MSE) between the predicted value and the actual value.

In this regard, in an embodiment, each task may calculate an independent regression loss based on an encoder module ECM and a regressor module RGM matching each task and perform learning based thereon, thereby preventing mutual interference.

The computing system 1000 may calculate the regression loss as such, thereby easily evaluating regression performance of a model.

Further referring to FIG. 14, in an embodiment, the computing system 1000 may calculate 2) an autoencoder loss based on the multi-tasking learning model MtLM that has obtained the geometric alignment vectors.

In detail, in an embodiment, the computing system 1000 may calculate an autoencoder loss based on an original latent vector and an original inverse vector according to the following [Mathematical Formula 2].

$$\begin{matrix}[ Mathematical formula 2 ] & \\ {L}_{auto} = MSE ( \text{?} , {z}_{\text{?}} ) & \end{matrix}$$

$$\text{?} \text{indicates text missing or illegible when filed}$$

That is, the computing system 1000 may calculate the autoencoder loss by calculating a mean squared error (MSE) between the latent vector and the inverse vector.

In an embodiment, the computing system 1000 may improve accuracy in a data transfer process through the autoencoder loss calculated as described above.

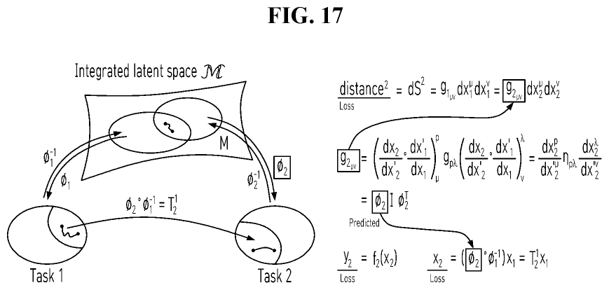

FIG. 17 illustrates an example of a diagram for describing an integrated latent space M mapping method according to an embodiment of the invention.

Referring to FIG. 17, in an embodiment, the computing system 1000 may learn a bidirectional transformation matrix (TM) that enables mapping to a common integrated latent space M for each task.

In detail, in an embodiment, the computing system 1000 may connect latent spaces of tasks using knowledge data that hold all labels for both tasks.

In this process, the computing system 1000 may calculate a consistency loss and a mapping loss according to an embodiment.

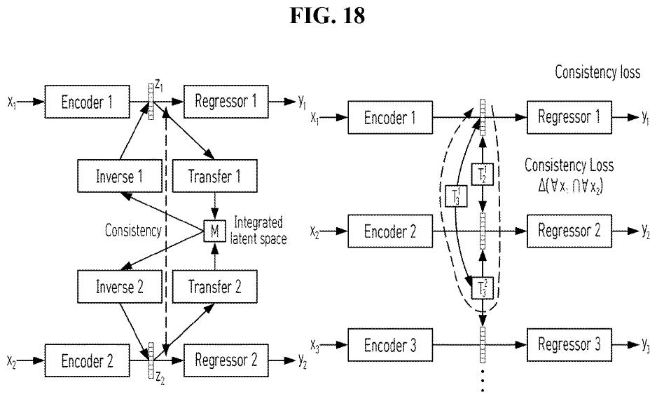

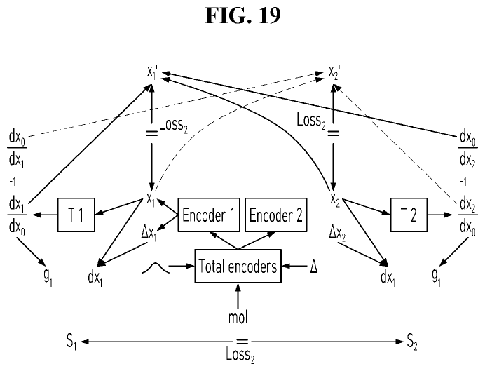

FIGS. 18 and 19 illustrate examples of diagrams for describing a consistency loss calculation method according to an embodiment of the invention.

In more detail, referring to FIGS. 14, 18, and 19, in an embodiment, the computing system 1000 may calculate 3) a consistency loss based on the multi-tasking learning model MtLM that has obtained the geometric alignment vectors.

In detail, in an embodiment, the computing system 1000 may calculate a consistency loss based on the perturbation transfer vector of the task “t” and the perturbation transfer vector of the task “s” according to the following [Mathematical Formula 3].

$$\begin{matrix}[ Mathematical Formula 3 ] & \\ {L}_{cons} = MSE ( \{ \overline{{m}_{\text{?}}} \} , \{ \overline{{m}_{\text{?}}} \} ) & \end{matrix}$$

$$\text{?} \text{indicates text missing or illegible when filed}$$

That is, the computing system 1000 may calculate the consistency loss by calculating the mean squared error (MSE) between the t-th perturbation transfer vector and the s-th perturbation transfer vector.

In this regard, in an embodiment, the computing system 1000 may derive a metric for calculating a distance in space from the transformation matrix (TM), and may perform learning such that distances in the latent spaces of respective tasks become identical based on the derived metric.

Accordingly, the computing system 1000 may more effectively implement geometric alignment among tasks.

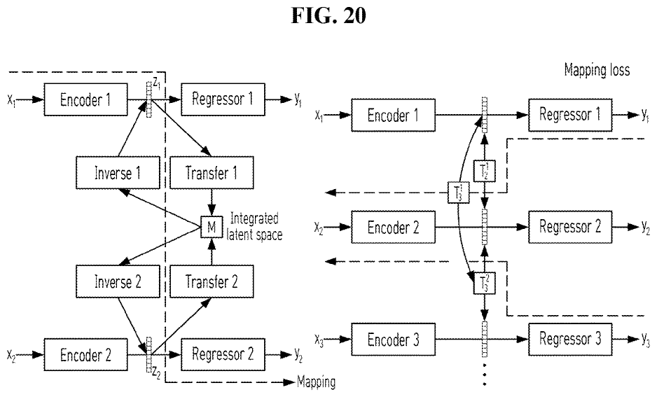

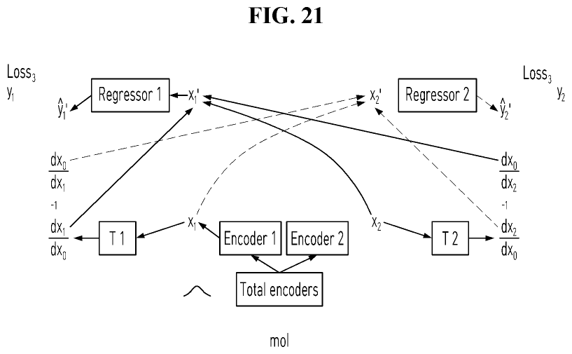

FIGS. 20 and 21 illustrate examples of diagrams for describing a mapping loss calculation method according to an embodiment of the invention.

In addition, referring to FIGS. 14, 20, and 21, in an embodiment, the computing system 1000 may calculate 4) a mapping loss based on the multi-tasking learning model MtLM that has obtained the geometric alignment vectors.

In detail, in an embodiment, the computing system 1000 may calculate a mapping loss based on an actual value corresponding to the task “t” and a predicted value based on an original inverse vector corresponding to the task “s” according to the following [Mathematical formula 4].

$$\begin{matrix}[ Mathematical formula 4 ] & \\ {L}_{map} = MSE ( {f}_{\text{?}} ( {f}_{\text{?}} ( {m}_{\text{?}} ) ) , {y}_{\text{?}} ) & \end{matrix}$$

$$\text{?} \text{indicates text missing or illegible when filed}$$

That is, the computing system 1000 may calculate the mapping loss by calculating a mean squared error (MSE) between the actual value of the task “t” and the predicted value based on the original inverse vector of the task “s”.

In an embodiment, the computing system 1000 may implement learning in which latent vectors are transferred from a latent space of one task to a latent space of another task and the other task is performed based on the transferred vectors by calculating the mapping loss as described above, thereby inducing latent characteristics to become similar to each other.

Accordingly, the computing system 1000 may evaluate the prediction performance of the vectors that have been transferred to the latent space of another task and induce learning in a direction to improve the prediction performance.

Further referring to FIG. 14, in an embodiment, the computing system 1000 may calculate 5) a distance loss based on the multi-tasking learning model MtLM that has obtained the geometric alignment vectors.

In detail, in an embodiment, the computing system 1000 may calculate an inter-task distance loss based on distances Sₗ (hereinafter, transfer vector displacements) between original transfer vectors and perturbation transfer vectors of each task according to the following [Mathematical Formula 5] and [Mathematical Formula 6].

In more detail, in an embodiment, the computing system 1000 may calculate a distance

$${s}_{\text{?}}^{\text{?}}$$

$$\text{?} \text{indicates text missing or illegible when filed}$$

(hereinafter, a t-th transfer vector displacement) between a t-th original transfer vector and a t-th perturbation transfer vector corresponding to a task “t” according to the following [Mathematical Formula (a) in 5].

In addition, the computing system 1000 may calculate a distance

$${s}_{\text{?}}^{\text{?}}$$

$$\text{?} \text{indicates text missing or illegible when filed}$$

(hereinafter, an s-th transfer vector displacement) between an s-th original transfer vector and an s-th perturbation transfer vector corresponding to the task “s” according to the following [Mathematical Formula (b) in 5].

$$\begin{matrix}[ Mathematical Formula 5 ] & \\ {s}_{\text{?}}^{\text{?}} = {m}_{\text{?}} - \{ \overline{{m}_{\text{?}}} \} & ( a )\end{matrix}$$

$${s}_{\text{?}}^{\text{?}} = {m}_{\text{?}} - \{ \overline{{m}_{\text{?}}} \} \qquad ( b )$$

$$\text{?} \text{indicates text missing or illegible when filed}$$

In addition, in an embodiment, the computing system 1000 may calculate the distance loss by calculating a mean squared error (MSE) between the t-th transfer vector displacement and the s-th transfer vector displacement according to the following [Mathematical Formula 6].

$$\begin{matrix}[ Mathematical Formula 6 ] & \\ {L}_{\text{?}} = \frac{1}{M} {\sum }_{\text{?}} MSE ( {s}_{\text{?}}^{\text{?}} {s}_{\text{?}}^{\text{?}} ) & \end{matrix}$$

$$\text{?} \text{indicates text missing or illegible when filed}$$

Here, “M” in [Mathematical Formula 6] refers to the number of perturbation points.

In this regard, in an embodiment, the computing system 1000 may define the t-th transfer vector displacement and the s-th transfer vector displacement as displacements in a source task and a target task, respectively.

Accordingly, the computing system 1000 may interpret the t-th transfer vector displacement and the s-th transfer vector displacement as being located in a flat Euclidean space, thereby more easily calculating the distance between the original transfer vector and the perturbation transfer vector.

Accordingly, the computing system 1000 may support maintaining consistency with respect to the latent space of the model in a more complete manner.

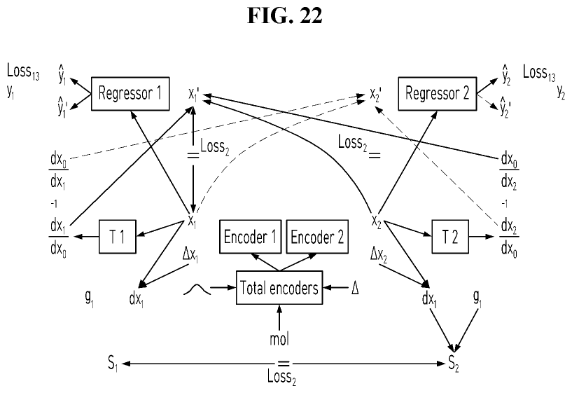

FIG. 22 illustrates an example of a diagram for describing an integrated loss calculation method according to an embodiment of the invention.

In addition, referring to FIGS. 14 and 22, in an embodiment, the computing system 1000 may calculate 6) an integrated loss based on the multi-tasking learning model MtLM that has obtained the geometric alignment vectors.

In detail, in an embodiment, the computing system 1000 may calculate an integrated loss obtained by a weighted sum of the above-described regression loss, autoencoder loss, consistency loss, mapping loss, and distance loss, according to the following [Mathematical Formula 7].

$$\begin{matrix}[ Mathematical Formula 7 ] & \\ {L}_{tot} = {L}_{reg} + α {L}_{auto} + β {L}_{cons} + γ {L}_{map} + δ {L}_{dis} & \end{matrix}$$

In this regard, in an embodiment, the computing system 1000 may apply a weight for each loss function so that each loss function may be optimized for a specific aspect of the model.

In an embodiment, the computing system 1000 may update parameters in a direction of minimizing the integrated loss by adjusting the importance of the loss function corresponding to each weight in the training process of the model by using the above-described weights.

In this regard, in an embodiment, the computing system 1000 may adjust a weight for at least one loss included in the integrated loss according to the physical property relationship information obtained in operation S103 described above.

In an embodiment, the computing system 1000 may determine or correct a value of the weight of the mapping loss, which is a loss supporting learning of relationships among physical properties, by reflecting the above-described physical property relationship information.

As a specific example, when a predetermined first physical property and a predetermined second physical property have a correlation and a high degree of association with each other, the computing system 1000 may reflect the physical property relationship information in a manner of enhancing learning based on the mapping loss by increasing the weight of the mapping loss.

As another example, when the predetermined first physical property and the second physical property do not have a correlation or have a low degree of association with each other, the computing system 1000 may reflect the physical property relationship information in a manner of weakening learning based on the mapping loss by reducing the weight of the mapping loss.

Accordingly, the computing system 1000 may more accurately apply the physical property relationship information detected from the previously published professional materials from various sources to training of the multi-tasking learning model MtLM.

Returning back to FIG. 12, in an embodiment, the computing system 1000 may also perform model optimization and parameter updates based on the geometric alignment loss calculated as described above (S207).

In detail, in an embodiment, the computing system 1000 may perform optimization and parameter updates for the multi-tasking learning model MtLM based on the above-described integrated loss.

In an embodiment, the computing system 1000 may calculate a gradient based on the integrated loss for each parameter of the multi-tasking learning model MtLM through backpropagation.

Then, the computing system 1000 may perform parameter updates for the multi-tasking learning model MtLM using the calculated gradient and a preset optimization algorithm (e.g., the decoupled weight decay regularization (AdamW) algorithm, etc.).

Accordingly, the computing system 1000 may implement optimization of the multi-tasking learning model MtLM based on the geometric alignment loss (in particular, the integrated loss).

As described above, in an embodiment, the computing system 1000 may perform optimization and parameter update training of the multi-tasking learning model MtLM through a combination of various loss functions calculated in a multi-faceted manner.

In this regard, each loss function may easily assist in improving the performance of the model by correcting the accuracy, consistency, and/or distance of knowledge data mapping.

Accordingly, the computing system 1000 may implement a multi-tasking model that provides improved performance by overcoming the regression problems of the small-scale data sets and the limitations of the existing transfer learning techniques, while operating more stably and providing improved generalization performance.

In addition, in an embodiment, the computing system 1000 may terminate training of the multi-tasking learning model MtLM (S209).

In detail, in an embodiment, the computing system 1000 may terminate the multi-tasking learning model MtLM training process described above when a preset training termination condition is satisfied.

In an embodiment, when the set training loop is completed, the computing system 1000 may terminate training of the multi-tasking learning model MtLM.

As described above, in an embodiment, the computing system 1000 may allow the multi-tasking learning model MtLM to simultaneously learn prediction tasks for at least two physical properties, thereby enabling the multi-tasking learning model MtLM to naturally learn, through transfer learning, correlations among the physical properties, which are learned together while learning the plurality of physical properties, and thus to perform more accurate predictions for each physical property.

In addition, accordingly, when experimental data for respective physical properties includes data of different molecular structure types, the computing system 1000 may train the multi-tasking learning model MtLM on various molecular structure types through transfer learning, thereby implementing task processing that operates robustly against variations in molecular structures and provides accurate predicted values for physical properties.

That is, the computing system 1000 according to an embodiment may perform pre-training that collectively trains the multi-tasking learning model MtLM on not only various physical property data but also relationships among various physical properties, thereby implementing effective multi-tasking learning that expands a model learning area and implements simultaneous/collective learning of a local pattern according to each physical property and a common principle shared across a plurality of physical properties.

Accordingly, the computing system 1000 may significantly improve processing performance and quality of various multi-tasking tasks based on the multi-tasking learning model MtLM pre-trained as described above, thereby expanding a range in which accurate prediction is available.

Returning to FIG. 10, the computing system 1000 according to an embodiment of the invention may also provide the trained multi-tasking learning model MtLM (S107).

That is, in an embodiment, the computing system 1000 may provide the multi-tasking learning model MtLM trained as described above in a predetermined method.

In an embodiment, the computing system 1000 may provide the multi-tasking learning model MtLM trained according to an embodiment of the invention in association with a predetermined application service (e.g., a material synthesis/evaluation service, a material physical property prediction service, and/or an optimal material recommendation service).

Specifically, according to an embodiment, the computing system 1000 may provide the multi-tasking learning model MtLM through a service that, when receiving a predetermined molecular structural formula, inputs the corresponding molecular structural formula to the multi-tasking learning model MtLM and outputs physical property values for a plurality of domains (i.e., physical properties) pre-learned by the multi-tasking learning model MtLM. In this regard, each physical property value may be provided in the form of a physical property value having the highest probability and/or a physical property value range for a specific probability.

On the contrary, according to embodiments, the computing system 1000 may provide the multi-tasking learning model MtLM through a service that inversely designs the pre-trained multi-tasking learning model MtLM, and when receiving a plurality of material physical property values, inputs the corresponding physical property values to the inversely designed multi-tasking learning model MtLM to output at least one molecular structural formula satisfying the physical property values.

As such, in an embodiment, the computing system 1000 may effectively support various multi-tasking task processing in various ways using the multi-tasking learning model MtLM having improved performance according to an embodiment of the invention.

As described above, in an embodiment of the invention, the computing system 1000 may enable mutual transfer and learning of knowledge data of a latent space for each task through geometric alignment in one integrated latent space in order to process multi-tasks for outputs corresponding to a plurality of domains, thereby providing the multi-tasking learning model MtLM that provides improved performance by overcoming the regression problems of the small-scale data sets and the limitations of the existing transfer learning techniques, while operating more stably.

Accordingly, the computing system 1000 may provide a transfer learning-based multi-tasking model that stably and robustly operates while exhibiting high generalization performance even in situations where an amount of given data is limited, where various task types are included, or where regression problems are mainly dealt.

In other words, even though a domain lacking experimental data (training data) exists among a plurality of domains (e.g., physical properties), the computing system 1000 may provide the multi-tasking learning model MtLM having improved prediction performance based on knowledge distilled through geometrical alignment-based transfer learning performed in association with other domains.

For example, when pre-training the multi-tasking learning model MtLM based on first-to-tenth physical properties for each of a plurality of molecular structural formulas and then receiving a first molecular structural formula including only data for the first-to-fifth physical properties, the computing system 1000 may more accurately predict respective values for the remaining sixth-to-tenth physical properties for the first molecular structural formula based on knowledge data transferred and distilled through the pre-learning, and generate and provide output data based thereon.

As described above, the computing system 1000 according to an embodiment of the invention may provide a multi-tasking model that implements effective geometric alignment-based transfer learning, guarantees high generalization performance, improves prediction accuracy for regression problems, supports normalization through combinations of various loss functions, and guarantees robust performance through a stable learning process.

As described above, a method and a system for adding tasks to a multi-tasking model according to an embodiment of the invention may perform transfer learning through geometric alignment in an integrated latent space for multi-tasks corresponding to a plurality of domains during pre-training, thereby accurately predicting an integrated output satisfying needs of the plurality of domains.

In addition, a method and a system for adding tasks to a multi-tasking model according to an embodiment of the invention may simultaneously train various prediction tasks corresponding to a plurality of domains in the transfer learning process to achieve collective learning of not only individual principles of the respective domains but also correlations between the domains and a common principle for the entire domains, thereby expanding a model learning area and also expanding a prediction acceptance range for each domain.

Accordingly, a method and a system for adding tasks to a multi-tasking model according to an embodiment of the invention may directly improve performance and quality of processing various multi-tasking tasks using the trained model.

In addition, a method and a system for adding tasks to a multi-tasking model according to an embodiment of the invention may implement mutual exchange of information by aligning geometric characteristics of the various prediction tasks, thereby easily supporting transfer of knowledge among mutually related data and improvement of prediction performance resulted therefrom.

Furthermore, accordingly, a method and a system for adding tasks to a multi-tasking model according to an embodiment of the invention may increase resistance to unnecessary interference information and increase stability of the model.

In addition, a method and a system for adding tasks to a multi-tasking model according to an embodiment of the invention may secure data sets for training by utilizing source data from various sources, thereby increasing the diversity of data used for model training and allowing a model to learn more information to improve learning performance.

In addition, a method and a system for adding tasks to a multi-tasking model according to an embodiment of the invention may predict a plurality of physical properties for a specific material by applying the multi-tasking learning model MtLM trained as described above to relationship predictions between a plurality of physical properties and materials, and provide a multi-tasking model capable of predicting a specific material satisfying a plurality of physical properties, thereby improving overall quality across related industries by providing a multi-tasking model that may be universally utilized for various materials.

In addition, a method and a system for adding tasks to a multi-tasking model according to an embodiment of the invention may transfer knowledge learned from a source task to a target task through transfer learning to solve data shortage problems, thereby providing a multi-tasking model that maintains high performance for multi-tasks even with small-scale data sets.

Therefore, a method and a system for adding tasks to a multi-tasking model according to an embodiment of the invention may expand the range of applicability to fields in which application of machine learning models had previously been difficult due to insufficient data or domain knowledge.

In addition, a method and a system for adding tasks to a multi-tasking model according to an embodiment of the invention may provide a specialized transfer learning technique that may be effectively applied to regression problems, thereby exhibiting high prediction performance even for complex regression problems such as molecular data sets.

In addition, a method and a system for adding tasks to a multi-tasking model according to an embodiment of the invention may optimize knowledge transfer between a source task and a target task through a Riemann geometric approach, thereby maintaining geometric consistency between tasks and improving the efficiency of transfer learning.

In addition, a method and a system for adding tasks to a multi-tasking model according to an embodiment of the invention may normalize various aspects of the model by combining multiple loss functions, thereby further improving generalization performance of the model.

### [Method for Providing Multi-Tasking Model Task Addition Service]

Hereinafter, a method for providing a multi-tasking model task addition service, in which the computing system 1000 according to an embodiment of the invention implements task addition of the multi-tasking model through geometric alignment in the integrated latent space M (manifold), will be described in detail.

That is, a specific method will be described below in detail, in which the computing system 1000 according to an embodiment of the invention performs additional training for multi-tasks corresponding to new domains (i.e., new physical properties) based on the multi-tasking learning model MtLM pre-trained as described above.

In this regard, the computing system 1000 according to an embodiment of the invention may freeze at least a portion of the pre-trained multi-tasking learning model (hereinafter, a pre-trained multi-tasking model) and perform the aforementioned additional training. Consequently, when predictions for new tasks are required, the system may not re-train the entire predictive model (i.e., the pre-trained multi-tasking model) for pre-learned tasks from scratch, but perform partial/selective additional training based on the tasks to be newly learned, thereby remarkably reducing the calculation complexity and time required for training.

Hereinafter, the method for adding tasks to a multi-tasking model according to an embodiment of the invention will be described in more detail with reference to the accompanying drawings, and descriptions overlapping with the foregoing may be summarized or omitted.

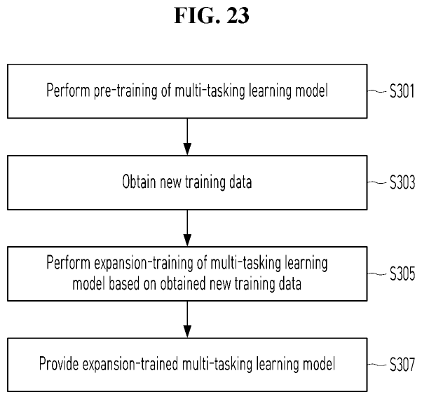

FIG. 23 is a flowchart for describing a method for adding tasks to a multi-tasking model according to an embodiment of the invention.

Referring to FIG. 23, the method for adding tasks to a multi-tasking model according to an embodiment of the invention may include: performing pre-training of the multi-tasking learning model (S301); obtaining new training data (S303); performing expansion-training of the multi-tasking learning model based on the obtained new training data (S305); and providing the expansion-trained multi-tasking learning model (S307).

Specifically, the computing system 1000 according to an embodiment of the invention may perform pre-training of the multi-tasking learning model (S301).

In detail, the computing system 1000 according to an embodiment of the invention may perform the pre-training of the multi-tasking learning model MtLM according to the multi-tasking model pre-training method as described above.

More specifically, referring further to FIG. 10, in an embodiment, the computing system 1000 may initialize the multi-tasking learning model MtLM (S101), obtain experimental data for pre-training (hereinafter, pre-training data) (S103), and train the multi-tasking learning model MtLM based on the obtained pre-training data (S105).

During this process, the computing system 1000 may collectively train n task processing units TPU corresponding to n (n≥2) domains (i.e., physical properties), respectively.

That is, in an embodiment, using the given pre-training data, the computing system 1000 may collectively train a plurality of task processing units TPU that perform learning and prediction based on a plurality of tasks (e.g., a plurality of sub-tasks) respectively for a plurality of domains (i.e., physical properties).

Furthermore, during the pre-training process, the computing system 1000 may train the embedding module EBM of the multi-tasking learning model MtLM.

In other words, in an embodiment, the computing system 1000 may train the embedding module EBM that compresses the dimensionality of given input data and projects and vectorizes the input data into a specific embedding space, using the given pre-training data.

Accordingly, the computing system 1000 may construct a multi-tasking learning model (i.e., a pre-trained multi-tasking model) that includes the plurality of task processing units TPU and the embedding module EBM optimized and updated in parameters according to the pre-training data.

Accordingly, the computing system 1000 may implement a multi-tasking learning model (i.e., a pre-trained multi-tasking model) that has learned a plurality of tasks (hereinafter, pre-training tasks) corresponding to a plurality of domains (i.e., physical properties).

In addition, the computing system 1000 according to an embodiment of the invention may obtain the new training data (S303).

Here, the new training data according to an embodiment may refer to experimental data used to learn a plurality of tasks (hereinafter, new training tasks) that are to be additionally learned after the completion of pre-training.

That is, in an embodiment, the new training data may be experimental data used to learn a plurality of tasks (i.e., new training tasks) corresponding to at least one domain (hereinafter, an additional domain) to be additionally learned, in addition to domains already learned through pre-training (hereinafter, existing domains).

Such new training data may include data including characteristic values of additional domains for a plurality of materials.

In summary, in the description according to an embodiment of the invention, experimental data used during pre-training are referred to as pre-training data, and experimental data used during additional training are referred to as new training data. Furthermore, a pre-learned plurality of tasks are referred to as pre-training tasks, and a plurality of tasks to be additionally learned are referred to as new training tasks.

In this regard, the new training tasks according to an embodiment may be tasks for predicting characteristic values corresponding to domains (i.e., physical properties) that have not been pre-learned, and may include cases where domains (i.e., physical properties) themselves are different and/or cases where domains (i.e., physical properties) are the same but experimental data corresponding thereto are different.

Here, cases where experimental data are different may include, for example, predicting solubility in a first solvent and solubility in a second solvent.

In an embodiment, such new training tasks may include a plurality of tasks (i.e., a plurality of sub-tasks) corresponding to each of at least one additional domain to be additionally learned (i.e., additional domain).

In other words, the new training tasks may include a plurality of sub-tasks for predicting characteristic values for each of at least one additional domain (i.e., additional physical property).

This may mean that the new training tasks may include a plurality of tasks (i.e., a plurality of sub-tasks) respectively processed by at least one task processing unit (hereinafter, additional task processing unit) corresponding to each additional domain.

In detail, in an embodiment, the computing system 1000 may obtain such new training data by applying the experimental data obtaining method described in step S103 above. In an embodiment, when pre-training has been completed for pre-training tasks corresponding to first to n-th (n≥2) domains, the computing system 1000 may obtain new training data for additional training of new training tasks corresponding to at least one (n+m)-th (m≥1) additional domain.

In addition, the computing system 1000 according to an embodiment of the invention may perform expansion-training of the multi-tasking learning model based on the obtained new training data (S305).

Here, expansion-training according to an embodiment of the invention may refer to a training method in which new tasks (i.e., new training tasks) are additionally learned while parameters that have been pre-learned by the multi-tasking learning model MtLM are fixed (frozen).

That is, the expansion-training according to an embodiment may be a training method in which additional training for new training tasks is performed while freezing at least some parameters that have been pre-learned by the multi-tasking learning model (i.e., the pre-trained multi-tasking model) that has been pre-trained using geometric alignment-based transfer learning.

In other words, the expansion-training according to an embodiment may be a model training method in which task processing units (i.e., additional task processing units) for processing new training tasks are added to a pre-trained multi-tasking model that includes a plurality of task processing units (hereinafter, existing task processing units) pre-trained through geometric alignment-based transfer learning.

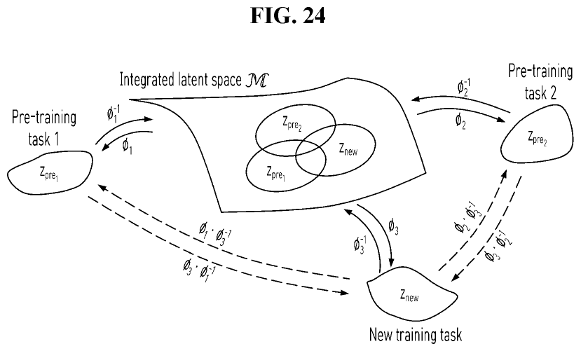

FIG. 24 illustrates an example of a conceptual diagram for describing a method for adding tasks to a multi-tasking model according to an embodiment of the invention, and FIG. illustrates an example of a conceptual diagram for describing an expansion-training method according to an embodiment of the invention.

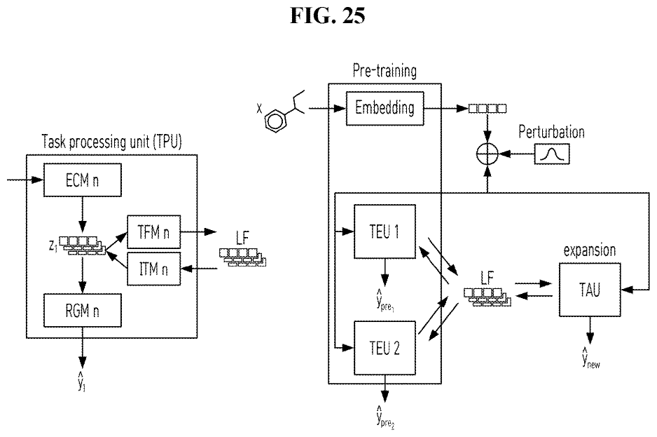

Referring to FIGS. 24 and 25, in an embodiment, the computing system 1000 may freeze the embedding module EBM and existing task processing units TEU of the pre-trained multi-tasking model optimized based on the pre-training data, as described above.

That is, in an embodiment, the computing system 1000 may fix parameters of the embedding module EBM and the existing task processing units TEU of the pre-trained multi-tasking model.

In this state, the computing system 1000 according to an embodiment may add m additional task processing units TAU, respectively processing new training tasks corresponding to the above-described m (m≥1) additional domains (i.e., additional physical properties), to the pre-trained multi-tasking model.

Further, the computing system 1000 may train the m additional task processing units TAU added to the pre-trained multi-tasking model based on the new training data described above.

In this regard, in an embodiment, the computing system 1000 may perform parameter updates for the newly added m additional task processing units TAU according to the above-described geometric alignment-based transfer learning method, while keeping the parameters pre-learned by the pre-trained multi-tasking model fixed.

In other words, in an embodiment, the computing system 1000 may perform optimization training for the newly added additional task processing units TAU in the geometric alignment-based transfer learning method using the new training data, while freezing the parameters pre-learned by the pre-trained multi-tasking model.

Accordingly, in an embodiment, the computing system 1000 may construct a multi-tasking learning model (hereinafter, an additionally trained multi-tasking model) that includes the n (n≥2) existing task processing units TEU and the embedding module pre-trained using pre-training data, and the m (m≥1) additional task processing units TAU additionally trained using new training data.

In this manner, the computing system 1000 according to an embodiment may implement an optimized multi-tasking model that has efficiently learned data regarding knowledge corresponding to new domains (i.e., physical properties) by partially and selectively performing geometric alignment-based transfer learning for new tasks while keeping pre-learned existing parameters of the multi-tasking model fixed.

As such, the computing system 1000 may support effective learning for various tasks by increasing module reusability and efficiency, thereby easily expanding the application scope of the multi-tasking model.

In addition, accordingly, the computing system 1000 may provide a multi-tasking model that maintains high performance while reducing training time required for processing new tasks.

Further, according to an embodiment, the computing system 1000 may fix (freeze) at least some parameters of the pre-trained multi-tasking model based on the above-described physical property relationship information.

In detail, in an embodiment, the computing system 1000 may obtain physical property relationship information between new training tasks corresponding to the above-described m (m≥1) additional domains (i.e., additional physical properties) and pre-training tasks.

In an embodiment, the computing system 1000 may obtain physical property relationship information based on new training data corresponding to the new training tasks and pre-training data corresponding to the pre-training tasks by interworking with a large language model that has performed predetermined pre-learning.

In addition, in an embodiment, the computing system 1000 may determine whether degree of correlation (correlation strength) information included in the obtained physical property relationship information satisfies a predetermined condition (e.g., equal to or less than a specific reference value).

In this regard, when the degree of correlation information satisfies the predetermined condition (e.g., equal to or less than the specific reference value), the computing system 1000 may freeze existing task processing units TEU corresponding to the relevant pre-training tasks.

That is, when degree of correlation is equal to or less than the predetermined reference value, the computing system 1000 may fix parameters of the related existing task processing units TEU.

With the parameters of the related existing task processing units TEU fixed as described above, the computing system 1000 may perform the additional training as described above.

Accordingly, the computing system 1000 may perform additional training that minimizes transfer learning between newly added tasks and existing tasks that have low mutual relevance, thereby preventing degradation of model performance due to unnecessary interference.

In addition, the computing system 1000 according to an embodiment of the invention may provide the expansion-trained multi-tasking learning model (S307).

In detail, in an embodiment, the computing system 1000 may provide the multi-tasking learning model expansion-trained as above (i.e., the additionally trained multi-tasking model).

For example, the computing system 1000 may provide the additionally trained multi-tasking model trained according to an embodiment of the invention in association with a predetermined application service (e.g., a material synthesis/evaluation service, a material physical property prediction service, and/or an optimal material recommendation service).

As a specific example, the computing system 1000 may provide the additionally trained multi-tasking model through a service for predicting a plurality of physical properties of a specific material, or through a service for predicting a specific material for a plurality of physical properties.

As described above, in an embodiment, the computing system 1000 may implement and provide a multi-tasking model efficiently optimized for n+m tasks by performing pre-training for n (n≥2) diverse tasks in the pre-training step and performing partial additional training based on m (m≥1) new tasks in the expansion-training step.

Accordingly, when prediction for new tasks is required, the computing system 1000 may not re-train the entire predictive model for pre-learned tasks from scratch, but perform partial/selective additional training based on the tasks to be newly learned, thereby remarkably reducing the calculation complexity and time required for training.

Furthermore, accordingly, the computing system 1000 may construct and provide a multi-tasking model that is less dependent on pre-learned tasks and that exhibits more consistent performance even when new tasks are added.

In this regard, the computing system 1000 may perform training of a multi-tasking model based on geometric alignment-based transfer learning, thereby further improving model performance more effectively compared to existing multi-tasking learning techniques.

As described above, the method and the system for adding tasks to a multi-tasking model according to an embodiment of the invention may expand tasks of the multi-tasking model through geometric alignment in an integrated latent space M, thereby maintaining high performance across various tasks even with small-scale data sets, while significantly reducing the calculation cost required for task learning to enhance the efficiency of the multi-tasking model.

In addition, the method and the system for adding tasks to a multi-tasking model according to an embodiment of the invention may expand tasks of the multi-tasking model by primarily performing pre-training of the multi-tasking model and secondarily performing additional training based on a parameter freezing technique for the pre-trained multi-tasking model. Consequently, when predictions for new tasks are required, the method and the system may not re-train the entire predictive model for pre-learned tasks from scratch, but perform partial/selective additional training based on the tasks to be newly learned, thereby remarkably reducing the calculation complexity and time required for training.

Furthermore, accordingly, the method and the system for adding tasks to a multi-tasking model according to an embodiment of the invention may construct and provide a multi-tasking model that is less dependent on pre-learned tasks and that exhibits more consistent performance even when new tasks are added.

Furthermore, accordingly, the method and the system for adding tasks to a multi-tasking model according to an embodiment of the invention may support effective learning for various tasks by increasing module reusability and efficiency, thereby facilitating the scalability of the multi-tasking model.

The embodiments according to the invention described above may be implemented in the form of program instructions executable through various computer components and recorded on a computer-readable recording medium. The computer-readable recording medium may include program instructions, data files, data structures, and the like alone or in combination. The program instructions recorded in the computer-readable recording medium may be specially designed and configured for the invention or may be known and available to those skilled in the field of computer software. Examples of the computer-readable recording medium include magnetic media such as a hard disk, a floppy disk and a magnetic tape, optical recording media such as a CD-ROM and a DVD, magneto-optical media such as a floptical disk, and hardware devices specially configured to store and execute program instructions such as a ROM, a RAM, a flash memory, and the like. Examples of program instructions include not only machine language codes such as those generated by a compiler, but also high-level language codes executable by a computer using an interpreter or the like. The hardware devices may be modified into one or more software modules to perform processing according to the invention, and vice versa.

The specific implementations described herein are merely embodiments, and do not limit the scope of the invention in any way. For the sake of brevity of the present document, descriptions of existing electronic components, control systems, software, and other functional aspects of the systems may be omitted. In addition, the line connections or connection members between the components illustrated in the drawings are intended to exemplarily represent functional connections and/or physical or circuit connections, and in actual devices, may be represented as various functional connections, physical connections, or circuit connections that are replaceable or additional. In addition, when there is no specific mention such as “essential”, “important”, or the like, a component may not be an essential component for the application of the invention.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method executed by a computer, the method comprising:
loading, by at least one processor of the computer, at least one artificial intelligence model stored in at least one memory, wherein the artificial intelligence model includes a multi-tasking model primarily-trained based on first experimental data for training the multi-tasking model on first multi-tasks;
obtaining, by the at least one processor, second experimental data for training the multi-tasking model on new tasks other than the first multi-tasks;
performing, by the at least one processor, secondary training of the primarily-trained multi-tasking model by ingesting the obtained second experimental data to the primarily-trained multi-tasking model, wherein the at least one processor is configured to perform additional training of the multi-tasking model on the new tasks based on geometric alignment in an integrated latent space while freezing at least some parameters of the primarily-trained multi-tasking model; and
providing, by the at least one processor, the secondarily-trained multi-tasking model.

2. The method of claim 1, further comprising performing, by the at least one processor, primary training of the at least one artificial intelligence model,
wherein the primary training of the multi-tasking model includes:
obtaining latent vectors corresponding to representations of data in a single integrated latent space based on the first experimental data;
calculating losses for the first multi-tasks based on the obtained latent vectors; and
updating parameters of the multi-tasking model based on the calculated losses.

3. The method of claim 2, wherein the performing of the primary training of the multi-tasking model includes:
obtaining geometric alignment vectors supporting geometric alignment among data corresponding to the first multi-tasks in the single integrated latent space based on the first experimental data;
calculating geometric alignment losses based on the obtained geometric alignment vectors; and
updating the parameters of the multi-tasking model based on the calculated geometric alignment losses.

4. The method of claim 2, wherein the updating of the parameters of the multi-tasking model includes updating parameters of N task processing units respectively corresponding to N domains of the first multi-tasks, where N≥2.

5. The method of claim 4, wherein the updating of the parameters of the multi-tasking model further includes updating parameters of an embedding module configured to project the first experimental data into a predetermined embedding space and convert the projected data into vector form.

6. The method of claim 1, wherein the new tasks include tasks having domains different from domains of the first multi-tasks, or tasks having the same domains as the first multi-tasks but having different experimental data corresponding to the same domains.

7. The method of claim 5, wherein the performing of the secondary training of the multi-tasking model further includes performing additional training of M task processing units configured to process the new tasks in the primarily-trained multi-tasking model, where M≥1.

8. The method of claim 7, wherein the performing of the additional training of the task processing units includes freezing the parameters of the N primarily-trained task processing units and the parameters of the primarily-trained embedding module, and performing additional training of the M task processing units.

9. The method of claim 8, wherein the performing of the additional training of the task processing units further includes:
obtaining geometric alignment vectors based on the second experimental data;
calculating geometric alignment losses based on the obtained geometric alignment vectors; and
updating parameters of the M task processing units based on the calculated geometric alignment losses.

10. The method of claim 1, wherein the experimental data include:
intrinsic material characteristic information specifying intrinsic characteristics of a predetermined material; and
material physical property-specific information specifying characteristic values of the material with respect to a plurality of physical properties.

11. The method of claim 10, wherein the providing of the secondarily-trained multi-tasking model includes:
inputting the intrinsic material characteristic information to the secondarily-trained multi-tasking model; and
manifesting the material physical property-specific information corresponding to the input intrinsic material characteristic information through at least one interface.

12. A system comprising:
at least one memory; and
at least one processor configured to read at least one application stored in the memory to execute instructions adding tasks to a multi-tasking model,
wherein the processor is configured to:
load at least one artificial intelligence model stored in the at least one memory, wherein the artificial intelligence model includes a multi-tasking model primarily-trained based on first experimental data for training the multi-tasking model on first multi-tasks;
obtain second experimental data for training the multi-tasking model on new tasks other than the first multi-tasks;
perform secondary training of the primarily-trained multi-tasking model by ingesting the obtained second experimental data to the primarily-trained multi-tasking model, wherein the at least one processor is configured to perform additional training of the multi-tasking model on the new tasks based on geometric alignment among task-specific latent spaces in an integrated latent space while freezing at least some parameters of the primarily-trained multi-tasking model; and
provide the secondarily-trained multi-tasking model.

13. The system of claim 12, wherein, in the primary training of the multi-tasking model, the processor is configured to:
obtain latent vectors corresponding to representations of data in a single integrated latent space based on the first experimental data;
calculate losses for the first multi-tasks based on the obtained latent vectors; and
update parameters of the multi-tasking model based on the calculated losses.

14. The system of claim 12, wherein:
the processor is configured to perform primary training of the at least one artificial intelligence model; and
in the primary training of the multi-tasking model, the processor is configured to:
obtain geometric alignment vectors supporting geometric alignment among data corresponding to the first multi-tasks in the single integrated latent space based on the first experimental data;
calculate geometric alignment losses based on the obtained geometric alignment vectors; and
update the parameters of the multi-tasking model based on the calculated geometric alignment losses.

15. The system of claim 12, wherein the new tasks comprise tasks having domains different from domains of the first multi-tasks, or tasks having the same domains as the first multi-tasks but having different experimental data corresponding to the same domains.

16. The system of claim 12, wherein the experimental data comprises:
intrinsic material characteristic information specifying intrinsic characteristics of a predetermined material; and
material physical property-specific information specifying characteristic values of the material with respect to a plurality of physical properties.
